(19) United States
(12) Patent Application Publication
(10) Pub. No.: US 2007/0226398 A1
(43) Pub. Date: Sep. 27, 2007

(54) Information reproducing apparatus and information reproducing method

(75) Inventor: Takero Kobayashi, Akishima-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KASUSHIKI KAISHA TOSHIBA

(21) Appl. No.: 11/723,665

(22) Filed: Mar. 21, 2007

(30) Foreign Application Priority Data
Mar. 22, 2006 (JP) 2006-079305

(51) Int. Cl. G06F 12/00

(52) U.S. Cl. 711/100

(57) ABSTRACT

A resume function is properly controlled, thereby making it possible to prevent a malfunction and enhance reliability. Provided are a content type storage section having stored therein disc determination information of a disc being played back, a playback processing section which plays back the disc, an interruption information storage section which, when playback interruption occurs while playing back the disc, stores information relating to a playback position in management information, and an interruption information processing section which, when playback interruption occurs during playback of the disc and the contents are of a first type, stores information relating to the playback position in the interruption information storage section, and, when the contents are of a second type, aborts information relating to the playback position.

### CROSS-REFERENCE TO RELATED APPLICATIONS

This application is based upon and claims the benefit of priority from Japanese Patent Application No. 2006-079305, filed Mar. 22, 2006, the entire contents of which are incorporated herein by reference.

### BACKGROUND

1. Field

One embodiment of the invention relates to an information reproducing apparatus and an information reproducing method, and particularly to a stable operation and malfunction prevention of a resume function.

2. Description of the Related Art

Recently, a Digital Versatile Disc (DVD) and a reproducing apparatus therefore have been prevalent, and a High Definition DVD (High Density DVD) enabling high-density recording and high quality recording has also been developed. Such a reproducing apparatus is disclosed in patent document 1.

This reproducing apparatus is compatible with plural types of discs and has a function of determining which disc has been mounted. This can contribute to improvement of operability without a user's inconvenience in disc check.

In addition, in general, a resume function is provided in a disc reproducing apparatus (Jpn. Pat. Appln. KOKAI Publication Nos. 9-44984 and 10-97766). The resume function stores in a memory the playback position information contained in playback management information as resume information when playback is interrupted in the middle of disc playback and a disc is demounted, or when the reproducing apparatus is powered OFF. Then, when the disc is remounted on the reproducing apparatus, and a play operation is made, the resume information is used as start position information for starting playback.

Note that, for a specific disc, when the disc has been demounted from the reproducing apparatus or when the reproducing apparatus has been powered OFF, it may be inconvenient if the above described resume function always operates. In a player and a method for playing advanced contents which are targeted by this invention, contents, programs, applications and the like can be externally acquired. In addition, external data and disc-recorded data are reproducibly displayed in combination or a playback route is changed in accordance with a user operation. Therefore, it is difficult for the player per se to precisely grasp a current playback status. In such a case, the resume function processes unreliable resume information.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are explanatory diagrams showing a configuration of standard contents and advanced contents;

FIGS. 2A to 2C are explanatory diagrams of discs in categories 1, 2, and 3;

FIG. 3 is an explanatory diagram showing a reference example of an enhanced video object (EVOB) using time map information (TMAPI);

FIG. 4 is an explanatory diagram to help explain an example of a volume space of the disc according to this invention;

FIG. 5 is an explanatory diagram showing an example of a directory and a file of the disc according to this invention;

FIG. 6 is an explanatory diagram showing a configuration of management information (VMG) and a video title set (VTS) according to this invention;

FIG. 7 is an explanatory diagram showing a startup sequence of a player model according to this invention;

FIG. 8 is a diagram showing a data structure of a DISCID. DAT file of the disc according to this invention;

FIG. 9 is a flowchart showing an exemplary operation of the apparatus according to this invention;

FIG. 10 is a flowchart showing another exemplary operation of the apparatus according to this invention;

FIG. 11 is a flowchart showing further another exemplary operation of the apparatus according to this invention;

FIG. 12 is a schematic explanatory diagram showing a pack-mixed state of primary EVOB-TY2 according to this invention;

FIG. 13 is an explanatory diagram showing a concept of recorded information of the disc according to this invention;

FIG. 14 is an explanatory diagram showing in detail a model of an advanced content player according to this invention;

FIG. 15 is an explanatory diagram showing an example of a video mixing model of FIG. 14;

FIG. 16 is an explanatory diagram to help explain an example of a graphics hierarchy in an operation of the apparatus according to this invention;

FIG. 17 is an explanatory diagram showing an example of a supply model of a network and persistence storage data in the apparatus according to this invention;

FIG. 18 is an explanatory diagram showing an example of a data store model in the apparatus according to this invention;

FIG. 19 is an explanatory diagram showing an example of a user input handling model in the apparatus according to this invention;

FIGS. 20A and 20B are diagrams to help explain an exemplary configuration of an advanced content;

FIG. 21 is a diagram to help explain an exemplary configuration of a playlist;

FIG. 22 is a diagram to help explain an example of allocation of presentation object on a timeline;

FIG. 23 is a diagram to help explain a case where trick play (such as chapter jump) of presentation objects is performed on the timeline.

FIG. 24 is a diagram to help explain an exemplary configuration of a playlist in the case where an object includes angle information;

FIG. 25 is a diagram to help explain an exemplary configuration of a playlist in the case where an object includes a multi-story;

FIG. 26 is a diagram to help explain an exemplary description of object mapping information in the playlist and its playback time;

FIG. 27 is a flowchart showing how a data cache is controlled at the time of apparatus operation using the playlist; and

FIG. 28 is a diagram showing a whole block configuration of a player according to this invention.

### DETAILED DESCRIPTION

Various embodiments according to the invention will be described hereinafter with reference to the accompanying drawings.

It is an object of this embodiment to provide an information reproducing apparatus and an information reproducing method capable of controlling a resume function according to a disc type, preventing a malfunction, and improving reliability.

One embodiment has: a playback processing section that, in order to reproduce a disc, reproduces the disc based on management information for playback; and a user interface for operating actions of the playback processing section. When a re-reproducing operation occurs after interruption of the playback via the user interface section in a disc of a predetermined type, the playback processing section has means for reading a playlist indicating at least playback procedures of contents, and then setting a playback state.

With the means mentioned above, processing relating to interruption information becomes appropriate, and a malfunction is prevented.

Embodiments of this invention will be specifically described with reference to the accompanying drawings.

<Introduction>

A description will be given with respect to types of contents.

In the following description, two types of contents are defined. One is Standard Content, and the other is Advanced Content. The Standard Content is composed of navigation data and video objects on a disc, and obtained by extending version 1.1 of the DVD-video standard.

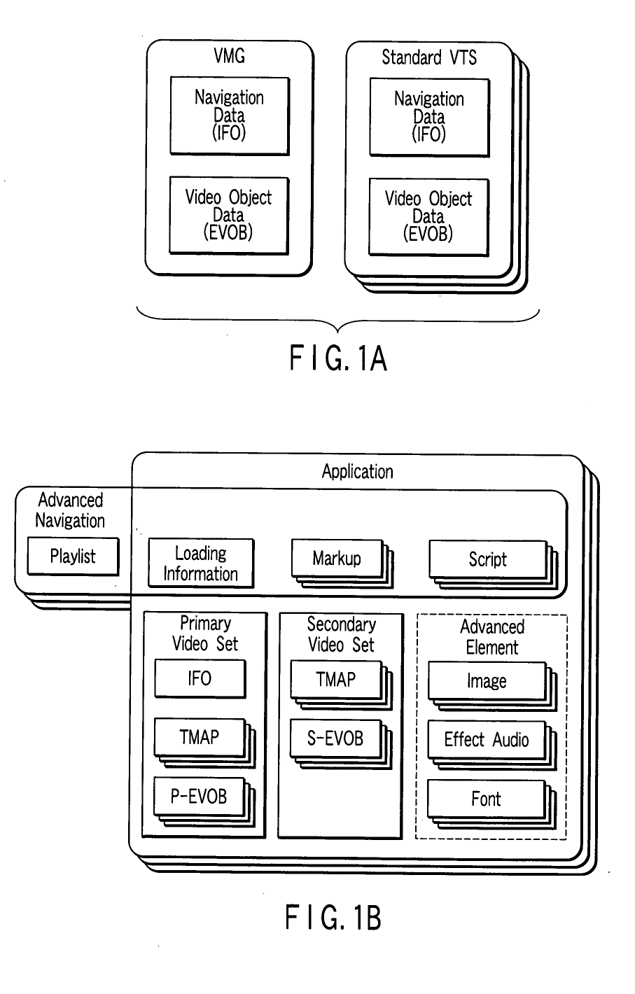

On the other hand, the Advanced Content is composed of: Advanced Navigation data such as a playlist, a Markup, Script Files; Advanced data such as a Primary/Secondary Video Set; and Advanced Elements (such as images, audios, and fonts). This advanced content needs to locate at least one playlist file and primary video set on a disc, and other data may be located on the disc or may be acquired from a server.

<Standard Content (refer to FIG. 1A)>

The Standard Content is an extension of the contents defined in version 1.1 of the DVD-video standard with respect to some of new functions of high-resolution videos and high quality audios, in particular. The Standard Content is basically composed of one VMG space and one or plural VTS spaces (referred to as “standard VTS” or mere “VTS”).

<Advanced Content (refer to FIG. 1B)>

The Advanced Content realizes more high-level interactivity in addition to audio and video extension realized by the Standard Content. The Advanced Content is composed of: Advanced Navigation such as a playlist, Markup files, and Script files, Advanced data such as Primary/Secondary Video Sets, and Advanced Elements (such as images, audios, and fonts), and the Advanced Navigation manages playback of the advanced data and the advanced content.

The playlist described in XML exists on a disc. In the case where the Advanced Content exists on the disc, a player first executes this file. The following pieces of information are provided using this file.
Object Mapping Information: information in the title for presentation objects mapped on Title Timeline.
Playback Sequence: playback information for each title described by title timeline.
Configuration Information: System configuration information such as data buffer alignment.

In the case where the Primary/Secondary Video Sets or the like exist, with reference thereto, a first application is executed in accordance with a description of a playlist. One application is composed of Markup (including content/styling/timing information) file(s), Script file(s), and Advanced data. The first markup file, script file(s), or other resources, configuring an application, are referred to in one manifest. Playback of advanced data such as the Primary/Secondary Video Sets and Advanced Elements are started by means of markup.

A structure of the Primary Video Set is composed of one VTS space exclusively used for this content. That is, this VTS does not include a navigation command or a multi-layered structure, but includes TMAP information or the like. In addition, this VTS can hold one main video stream, one sub-video stream, 8 main audio streams, 8 sub-audio streams, and subtitles. This VTS is called “Advanced VTS”.

The Secondary Video Set is used when video/audio data is added to the Primary Video Set and is used when only audio data is added thereto.

The Secondary Video Set is recorded on a disc or is acquired from a server as one or plural files. In this file, data is recorded on the disc. Moreover, in the case where there is a need for reproducing the recorded data at the same time with the Primary Video Set, they are temporarily stored in a file cache before playback. On the other hand, in the case where the Secondary Video Set exists on a web site, there is a need for temporarily saving the whole data in a file cache (“Downloading”) or continuously saving part of the data in a streaming buffer, and the stored data is reproduced at the same time without causing a buffer overflow while data is downloaded from a server (“Streaming”).

Description of Advanced Video Title Set (Advanced VTS)

The Advanced VTS (also called Primary Video Set) is utilized in a video title set for advanced navigation. That is, the following is defined to be compatible with the standard VTS.

1) Advanced Enhancement of EVOB
One main video stream and one sub-video stream
8 main audio streams and 8 sub-audio streams
32 sub-picture streams
One advanced stream

2) Integration of Enhanced EVOB Set (EVOBS)
Integration of both of menu EVOB and title EVOS

3) Elimination of Multi-layered Structure
No title, PGC (Program Chain), PTT (Part of Title), or Cell
Cancellation of navigation command and UOP (User Operation) control

4) Introduction of New Time Map Information (TMAPI)
One TMAPI corresponds to one EVOB, and is stored as one file.
Part of the NV_PCK internal information is simplified.

Description of Interoperable VTS

An interoperable VTS is a video title set supported under an HD DVD-VR standard. Under the instant standard, i.e., under the HD DVD-video standard, this interoperable VTS is not supported, i.e., a content author cannot produce a disc containing the interoperable VTS. However, an HD DVD-video player supports playback of the interoperable VTS.

<Disc Categories>

Under this standard, three types of discs (disc of category 1/disc of category 2/disc of category 3) defined below are accepted.

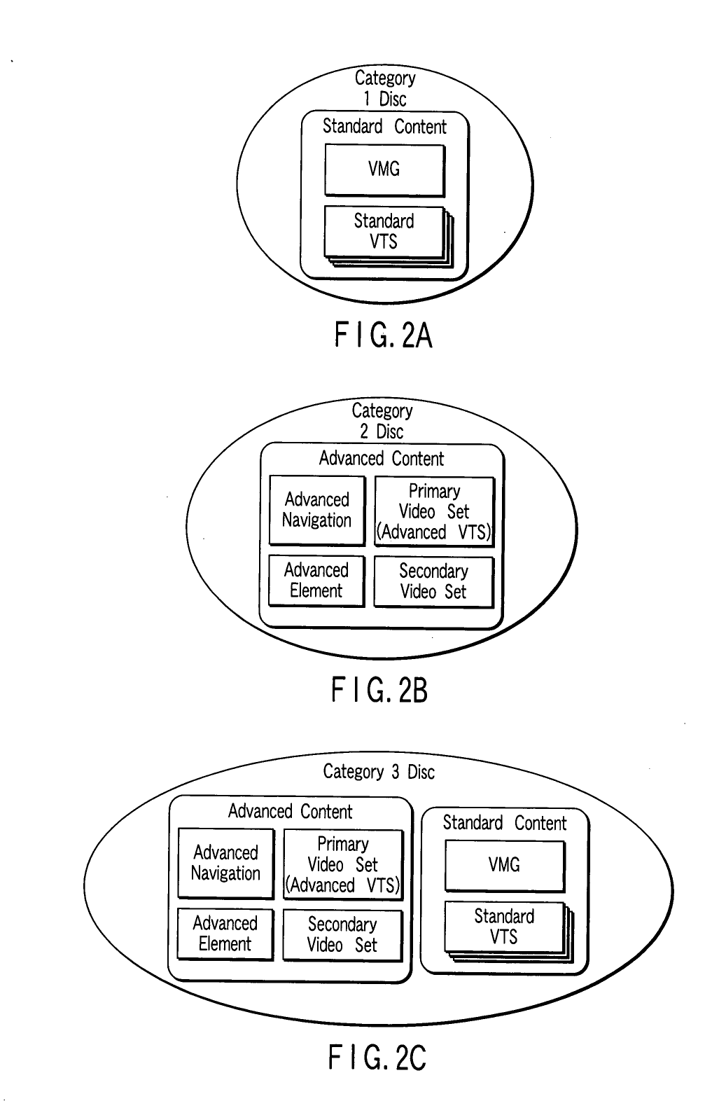

Description of Disc of Category 1 (Refer to FIG. 2A for an Exemplary Configuration Thereof)

This disc contains only a Standard Content composed of one VMG and one or plural standard VTS. That is, this disc does not contain Advanced VTS or Advanced Content.

Description of Disc of Category 2 (refer to FIG. 2B for an Exemplary Configuration Thereof)

This disc contains only an Advanced Content composed of an Advanced Navigation, a Primary Video Set (Advanced VTS), a Secondary Video Set, and Advanced Elements. That is, this disc does not contain Standard Content such as VMG or Standard VTS.

Description of Disc of Category 3 (Refer to FIG. 2C for an Exemplary Configuration Thereof)

This disc contains Advanced Content composed of an Advanced Navigation, a Primary Video Set (Advanced VTS), a Secondary Video Set, and Advanced Elements and a Standard Content composed of VMG (Video Manager) and one or plural standard VTS. However, in this VMG, neither FP_DOM nor VMGM_DOM exists.

This disc contains Standard Content. Basically, this disc follows rules of the disc of category 2. Furthermore, this disc contains a transition from an advanced content playback state to a standard content playback state, and contains its reversed transition.

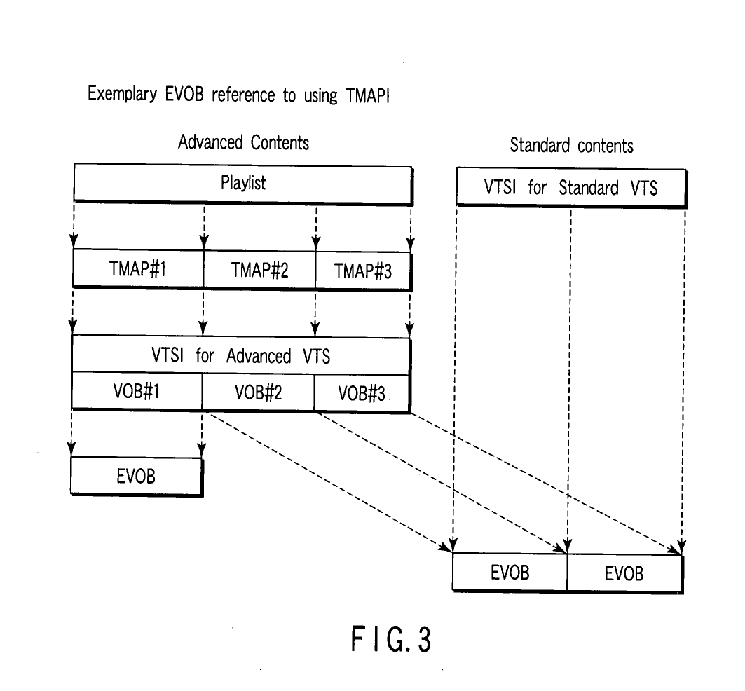

Description of Utilization of Standard Content by Advanced Content (FIG. 3 Shows How Standard Content is Utilized as Described above)

The Standard Content can be utilized by an Advanced Content. VTSI (Video Title Set Information) of Advanced VTS can refer to EVOB, and the latter can also refer to it using TMAP in accordance with VTSI of Standard VTS. However, EVOB can include HLI (Highlight Information), PCI (Program Control Information) and the like, and is not supported by the Advanced Content. In playback of such EVOB, for example, HLI and PCI are ignored in the Advanced Content.

<Structure of Volume Space>

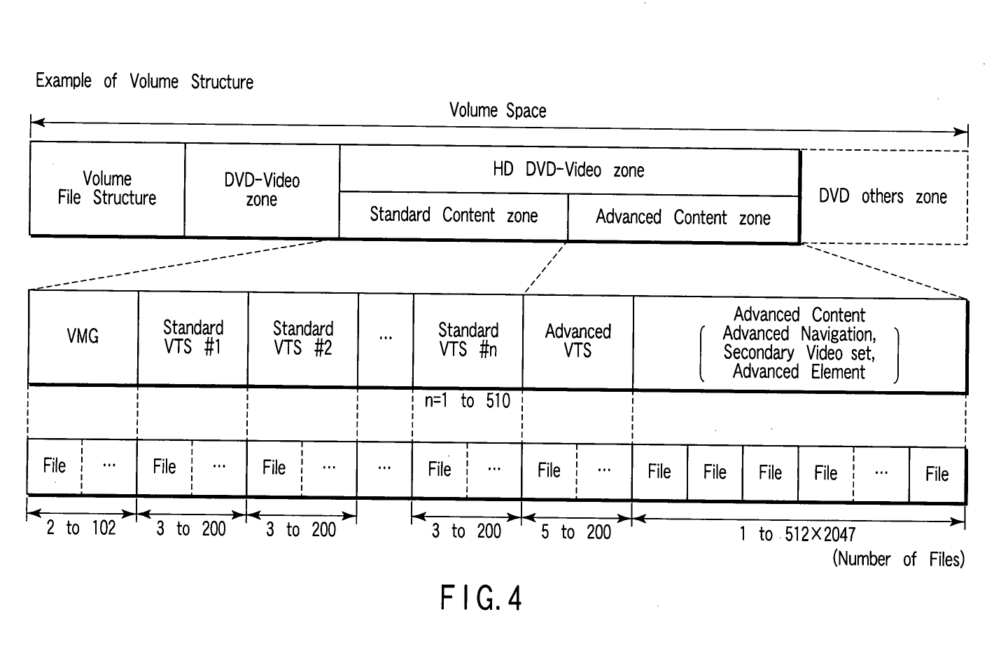

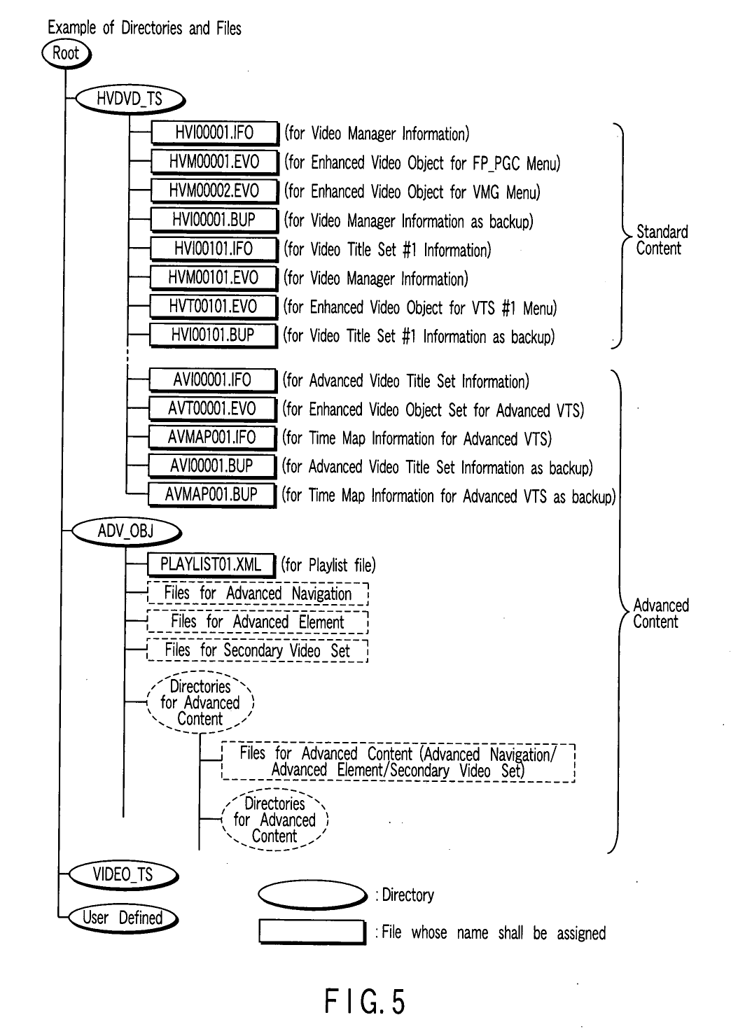

As shown in FIG. 4, a volume space of an HD DVD-video disc is composed of elements as described below.

1) Volume and File Structure

This is allocated for a UDF structure.

2) Single DVD-Video Zone

This may be allocated for a data structure of a DVD-video format.

3) Single HD DVD-Video Zone

This may be allocated for a data structure of a DVD-video format. This zone is composed of a “standard content zone” and an “advanced content zone”.

4) DVD Others Zone

This may be used for applications other than a DVD-video or an HD DVD-video.

<Rules Relating to Directories and Files (FIG. 5)>

A description will be given with respect to requirements for files and directories associated with the HD DVD-video disc. In FIG. 5 showing directories, descriptions of the left side portions enclosed in boxes are file names.

HVDVD_TS directory

An “HVDVD_TS” directory exists immediately under a root directory. All files associated with one VMG, one or plural standard video sets, and one advanced VTS (primary video set) exist under this directory.

Video Manager (VMG)

One piece of video manager information (VMGI) “HV00010. IFO”, a first play program chain menu enhanced video object (FP_PGCM_EVOB) “HV000M01. EV0”, backup video manager information (VMGI_BUP) “HV000101. BUP”, a video manager menu enhanced video object set (VMGM_EVOBS) “HV000M02. EVO” are recorded under the HVDVD_TS directory as configuration files.

Standard Video Title Set

Video title set information (VTSI) “HV001101. IFO” and backup video title set information (VTSI_BUP) “HV001101. BUP” are recorded under the HVDVD_TS directory as configuration files. In addition, a video title set menu enhanced video object set (VTSM_EVOBS) “HV001M01. EVO” and a title enhanced video object set (VTSTT_VOBS) “HV001T01. EVO” are also configuration files under the HVDVD_TS directory.

Advanced Video Title Set (Advanced VTS)

One piece of video title set information (VTSI) “HVA00001. VT1” and one piece of backup video title set information (VTSI_BUP) “HVA00001. BUP” can be recorded under the HVDVD_TS directory as configuration files.

Pieces of video title set time map information (VTS_TMAP) #1 (for titles) and #2 (for menus), “TITLE00. MAP” and “MEMU000. MAP”; and pieces of backup video title set time map information (VTS_TMAP_BUP) #1 and #2, i.e., “TITLE00. BUP” and “MENU000. BUP” are composed of files under the HVDVD_TS directory, respectively.

Files “TITLE00. EVO” and “MENU000. EVO” of enhanced video objects #1 and #2 for an enhanced video title set are also configuration files under the HVDVD_TS directory.

The following rules are applied to file names and directory names under the HVDVD_TS directory.

ADV_OBJ Directory

An “ADV_OBJ” directory is immediately under the root directory. All of startup files belonging to Advanced Navigation exist in this directory. All of the files of Advanced Navigation, Advanced Elements, and Secondary Video Set exist in this directory.

In addition, immediately under this directory, a file “DISCID. DAT” unique to an advanced system is provided. This file is a disc ID data file, and a detailed description thereof will be given later.

All of the playlist files exist immediately under this directory. Any of the files of Advanced Navigation, Advanced Elements, and Secondary Video Set can be placed immediately under this directory.

playlist

Each playlist file can be placed by a file name such as “VPLIST % % %. XPL or APLIST % % % XPL”, for example, immediately under the “ADV_OBJ” directory. The file names “% % %” are continuously allocated in ascending order from “000” to “999”. A playlist file having the greatest number is first processed (when loading a disc).

Advanced Content Directory

An “Advanced Content other directory” can be placed only under the “ADV_OBJ” directory. Any of files of an Advanced Navigation, Advanced Elements, and a Secondary Video Set can be placed under this directory.

Advanced Content File

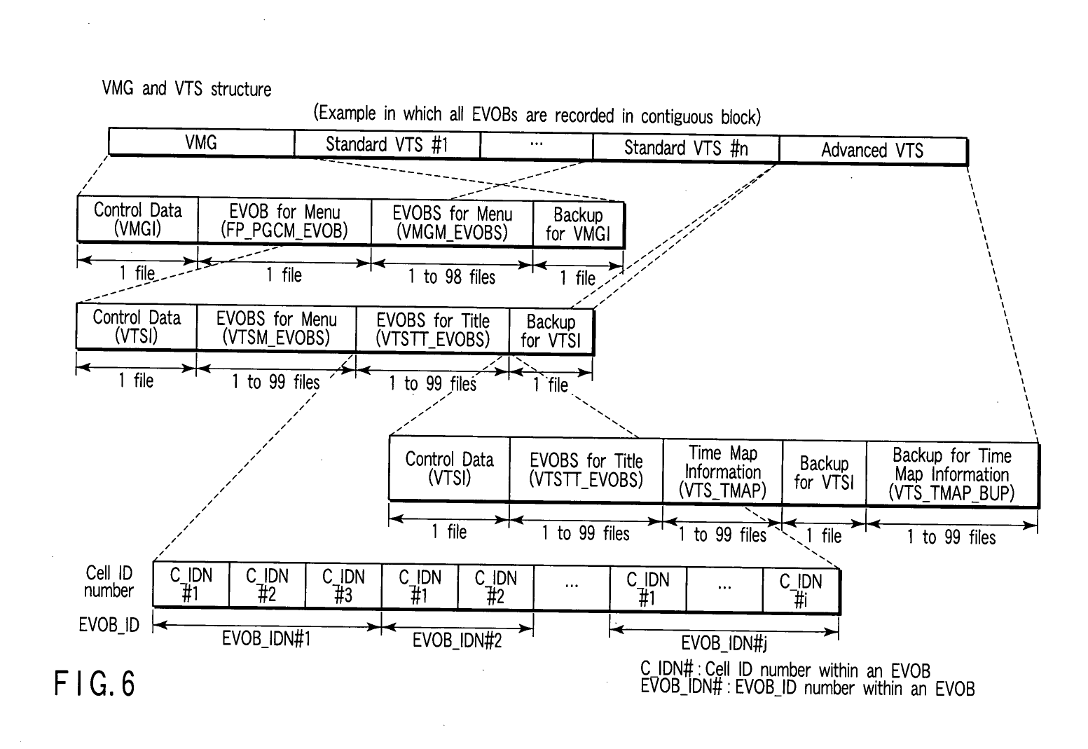

A total number of files under the “ADV_OBJ” directory is limited to 512×2047, and a total number of files existing in each directory is less than 2048. This file name is composed of “d” characters or “d1” characters. This file name is composed of a main body, a period, and an extension. An example of the directory/file structure described above is shown in FIG. 6.

<Structure of Video Manager (VMG) (FIG. 6)>

VMG is a table of contents of all video title sets existing in an “HD DVD-video zone”. As shown in FIG. 6, VMG is composed of: control data called VMGI (Video Manager Information); a first play PGC menu enhanced video object (FP_PGCM_EVOB); a BMG menu enhanced video object set (VMGM_EVOBS); and control data backup (VMGI_BUP). The control data is static information required to reproduce a title, and provides information for supporting a user operation. FP_PGCM_EVOB is an enhanced video object (EVOB) used to select a menu language. VMGM_EVOBS is a set of enhanced video objects (EVOB) used for a menu that supports a volume access.

<Structure of Standard Video Title Set (Standard VTS)>

VTS is a set of titles. As shown in FIG. 6, each VTS is composed of: control data called VTSI (Video Title Set Information); a VTS Menu Enhanced Video Object Set (VTSM_EVOBS); a Title Enhanced Video Object Set (VTSTT_EVOBS); and Backup Control Data (VTSI_BUP).

<Structure of Advanced Video Title Set (Advanced VTS)>

This VTS is composed of only one title. As shown in FIG. 6, the VTS is basically composed of: control data called VTSI; a Title Enhanced Video Object Set (VTSTT_EVOBS) in one VTS; Video Title Set Time Map Information (VTS_TMAP); Backup Control Data (VTSI_BUP); and Backup of the Video Title Set Time Map Information (VTS_TMAP_BUP).

<Structure of Enhanced Video Object Set (EVOBS)>

EVOBS is a set of enhanced video objects composed of videos, audios, and sub-pictures (FIG. 6).

The following rules are applied to EVOBS.

1) In one EVOBS, EVOB is recorded in continuous blocks and interleaved blocks.

2) One EVOBS is composed of one or plural EVOB. EVOB_ID numbers are assigned in ascending order starting from EVOB having the smallest LSN (logic sector number) in EVOBS.

3) One EVOB is composed of one or plural cells. C_ID numbers are assigned in ascending order starting from a cell having the smallest LSN in EVOB.

4) The cells in EVOBS can be identified using EVOB_ID numbers and C_ID numbers.

“System Model”

<Overall Startup Sequence>

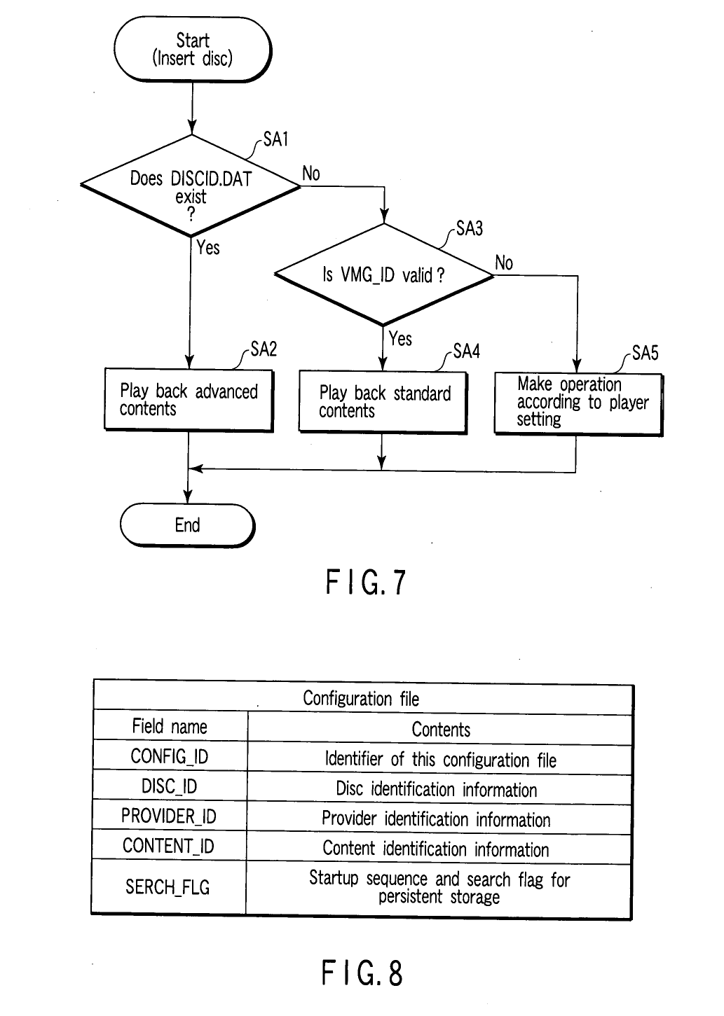

FIG. 7 shows a flowchart of a startup sequence of an HD DVD player. After a disc has been inserted, the player first checks the existence of a file “DISC. DAT” under the “ADV_OBJ” directory in a management information region (step SA1). “DISC. DAT” is a file specific to a recording medium which can handle advanced content. When “DISC. DAT” is confirmed, the routine moves to an advanced content playback mode (step SA2). At this time, a disc of category 2 or 3 is used. In the case where “DISC. DAT” has not confirmed in step SA1, it is checked whether or not “VMG_ID” is valid (step SA3). Whether or not “VMG ID” is valid is checked as follows. If a disc belongs to category 1, “VMG_ID” is “HVDVD-VMG100”. In addition, bits 0 to 3 of VMG_CAT that is a category description region indicates that “No Advanced VTS exists”. In this case, the player moves to a standard content playback mode (step SA4). Further, in the case where it is determined that the disc does not belong to any HD_DVD type, an operation that follows the player's setting is ready (step SA5).

When the routine moves to advanced content playback, the player moves to an operation of reading and reproducing “playlist. xml (Tentative)” of the “ADV_OBJ” directory under the root directory. A startup sequence, a memory for that purpose and the like may be provided in a data access manager or a navigation manager.

Here, FIG. 8 shows a data structure of the previously described “DISCID. DAT”. “DISCID.DAT” is a file name, and is also called a configuration file. In this file, a plurality of fields are allocated, and these fields include “CONFIG_ID”, “DISC_ID”, “PROVIDER_ID”, “CONTENT_ID”, “SEARCH_FLAG” and the like.

In the “CONFIG_ID” field, “HDDVD-V_CONF” for identifying this file is described in ISO8859-1 codes.

A disc ID is described in the “DISC_ID” field.

A studio ID is described in “PROVIDER_ID”. Using this information, a content provider can be identified. Persistent Storage has an independent area for storing data by provider ID for each provider. Advanced content identification information is described in the “CONTENT_ID” field. This content ID can also be utilized to make a search for a playlist file contained in Persistent Storage.

The “SEARCH_FLAG” field is a search flag for making a search for a file in Persistent Storage when a start sequence occurs. When this flag is set to 1, it indicates that Persistent Storage is not included in playlist detection, and when the flag is set to 0, it indicates that Persistent Storage is included in playlist detection.

Therefore, the above configuration file data is utilized to identify a region allocated to a disc, in Persistent Storage. In addition, this data is also utilized in the case where disc authentication is carried out through a network. For example, provider information exists, and thus, utilizing this provider information, a search can be made for a server who owns information relating to this disc.

The player according to the present invention executes processing relating to a data structure of the above “DISCID.DAT” in the case where a resume function operates.

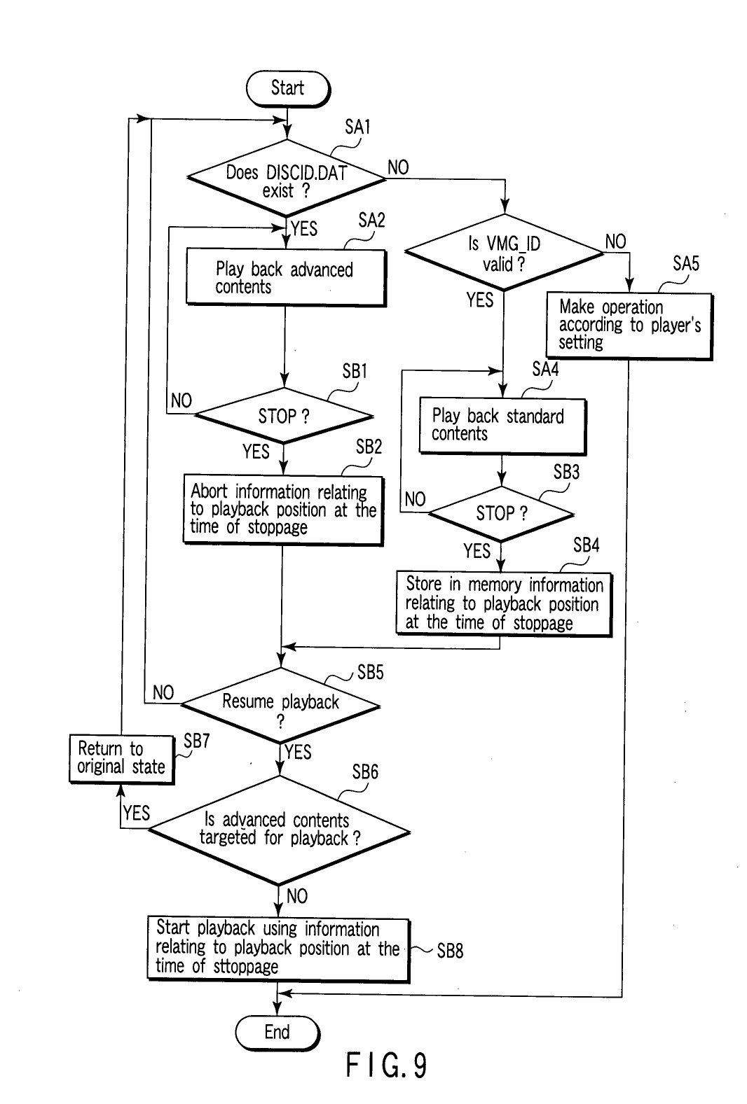

FIG. 9 shows flow of operation in the case where a resume function of the player who reproduces at least Advanced Content and Standard Content operates.

This processing is executed using a resume manager described later, for example. The resume manager includes at least a content type memory, an interruption information memory, and an interruption information processing section.

In the case where a stop operation has been made in an advanced content playback state (step SB1), information relating to a playback position at the time of stoppage is aborted. Namely, a predetermined resume information memory for storing resume information is cleared. In contrast, in the case where the stop operation has been made in a standard content playback state (step SB3), information relating to a playback position at the time of stoppage is stored in the predetermined resume information memory (step SB4). Storage information includes, for example, video title numbers, program chain numbers, cell numbers, playback logic address information and the like.

Next, when a play operation has been made, determination is made as to whether or not it is resume playback. The determination of whether or not it is resume playback is enabled in accordance with a variety of methods. For example, a memory for storing a plurality of disc IDs of a reproduced disc is prepared, and then, it is determined whether or not the disc ID of the disc mounted on the apparatus matches the latest storage disc ID. In addition, a user may operationally input the fact that it is resume playback. In the case where the disc ID of the disc mounted on the apparatus does not match the latest storage disc ID or where an operational input of resume playback has not been made, the routine reverts to step SA1.

In the case where it has been determined that it is resume playback occurs (step SB5), determination is made as to whether or not a Presentation Object is Advanced Content. This determination may be made as to whether or not “DISCID. DAT” exists again or the contents of the resume information memory may be checked. For example, in the case where information relating to a playback position does not exist in the resume information memory, the advanced content is targeted for playback, and in the case where the information relating to a playback position exists, the standard content is targeted for playback (step SB6).

In the case where the advanced content is targeted for playback, the routine reverts to a first playback start position (step SB7), and then, to a first advanced content playback state. However, in the case where the standard content is targeted for playback, the contents of a resume information memory (information relating to a playback position at the time of stoppage) is referenced, and then, playback is restarted (step B8).

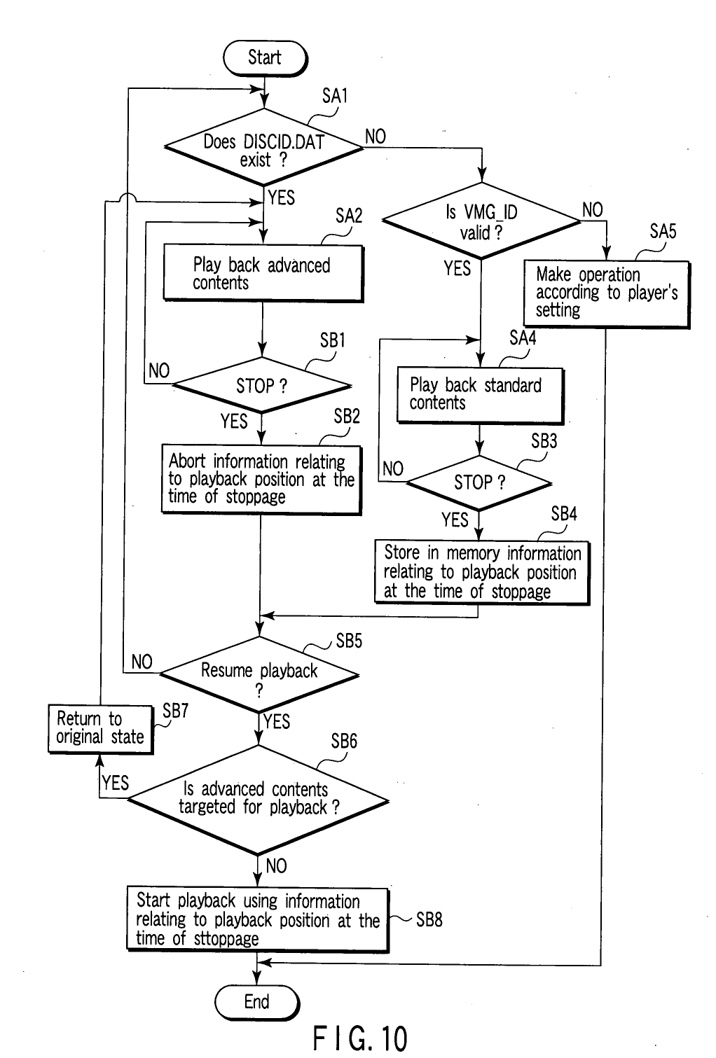

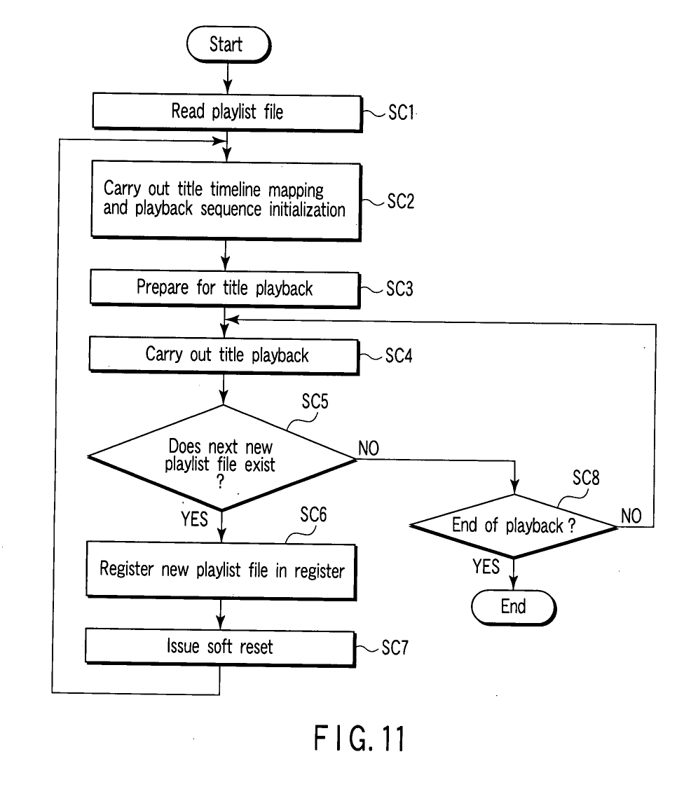

FIG. 10 shows another embodiment of procedures shown in FIG. 9. In FIG. 9, while the routine reverts to step SA1 in the case where the playback object at the time of resume playback is Advanced Content, DISCID.DAT may be left in a memory in the case of Advanced Content, and then, the routine may revert to step SA2.

In this case, as shown in FIG. 11, the routine reverts to advanced content playback.

“playlist file reading” is carried out (step SC1). Title timeline mapping and playback sequence initialization are carried out using a next playlist (step SC2). Next, first title playback is ready (step SC3), and then, title playback is started (step SC4). In this manner, an advanced content player reproduces a title. Next, it is determined whether or not a new playlist file exists (step SC5). An advanced application that executes updating procedures is required to update advanced content playback. In the case where the advanced application updates that presentation, the advanced application on the disc must make a search for, and update a script sequence in advance. A programming script makes a search for a designated data source, generally a network server, whether or not an available new playlist file exists. In the case where a new playlist file exits, the registration of the playlist file is executed (step SC6). In the case where an available new playlist file exists, a script executed by a programming engine downloads it in a file cache, and registers it in an advanced content player. Then, when the new playlist file is registered, an Advanced Navigation issues soft reset API (step SC7), and then, restarts a startup sequence. The soft reset API resets all of the current parameters and playback configurations, and then, restarts startup procedures immediately after “playlist file reading”. “System configuration change” and the subsequent procedures are executed based on the new playlist file.

In the case where the Advanced Content is reproduced, the content per se including applications undergo interactive behavior in response to a user operation. Therefore, a next playback route or playback position on the contents is changed or switched in response to the user operation. As a result, the player per se cannot grasp interruption position information.

The following method can be used in order to execute resume playback in a simulative manner.

(1) User-operated timing information and operational command information are stored in an additional memory.

(2) After playback has been interrupted, when resume playback occurs, playback processing is executed in accordance with a playlist. In this case, after decode processing has been carried out in an inactive state, while time required for decoding is eliminated, data processing is carried out at a high speed in accordance with the stored timing information and operational command information.

(3) Then, a content playback route is simulated based on the timing information.

(4) Then, when the last timing information and operating command information are reached, decode processing is started. In accordance with such a method, although it is possible to carry out resume playback in a simulative manner, a playlist must be executed from an initial state.

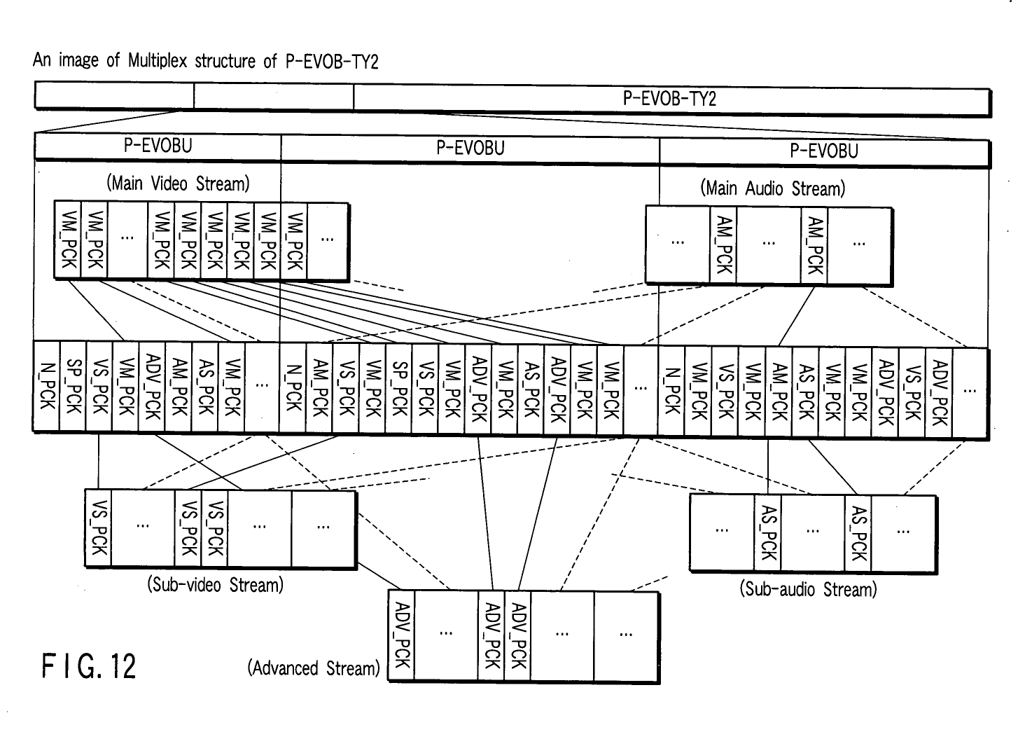

FIG. 12 is an image of a multiplexed structure of P-EVIOB-TY2 as an advanced content. P-EVOB-TY2 includes an enhanced video object unit (P-EVOBU). P-EVOBU includes a Main Video stream, a Main Audio stream, a Sub Video stream, a Sub Audio stream, and an Advanced stream.

At the time of playback, a packet-multiplexed stream of P-EVOB-TY2 is inputted to a De-Multiplex via a Track buffer. Here, packets are demultiplexed according to their types, and then, the demultiplexed packets are supplied to a Main Video Buffer, a Sub Video Buffer, a Sub-Picture Buffer, a PCI Buffer, a Main Audio buffer, and a Sub Audio buffer. The outputs from these buffers can be decoded using the corresponding Decoder.

<Data Source>

Now, a description will be given with respect to types of data sources that can be used for advanced content playback.

<Disc>

A disc 131 is a mandatory data source for advanced content playback. An HD DVD player must be equipped with an HD DVD disc drive. Advanced Content needs to carry out authoring so as to enable playback even in the case where an available data source is only a disc and a mandatory persistent storage.

<Network Server>

A network server 132 is an optional data source for advanced content playback, and the HD DVD player must be equipped with network access capability. A current disc content provider generally operates the network server. The network server is, in general, located over the Internet.

<Persistent Storage>

A Persistent Storage 133 is divided into two categories.

One is called a “Fixed Persistent Storage”. This is a mandatory persistent storage provided as accessories to the HD DVD player. A typical example of this storage includes a flash memory. The minimum capacity of the Fixed Persistent Storage is 128 MB.

Other devices are optional, and are called “Auxiliary Persistent Storage”. These devices may be removable storage devices such as a USB memory/HDD or a memory card. One of the possible auxiliary persistent storage devices includes NAS. This standard does not stipulate device packaging. These devices must follow an API model for persistent storage.

<Disc Data Structure>

<Data Type on Disc>

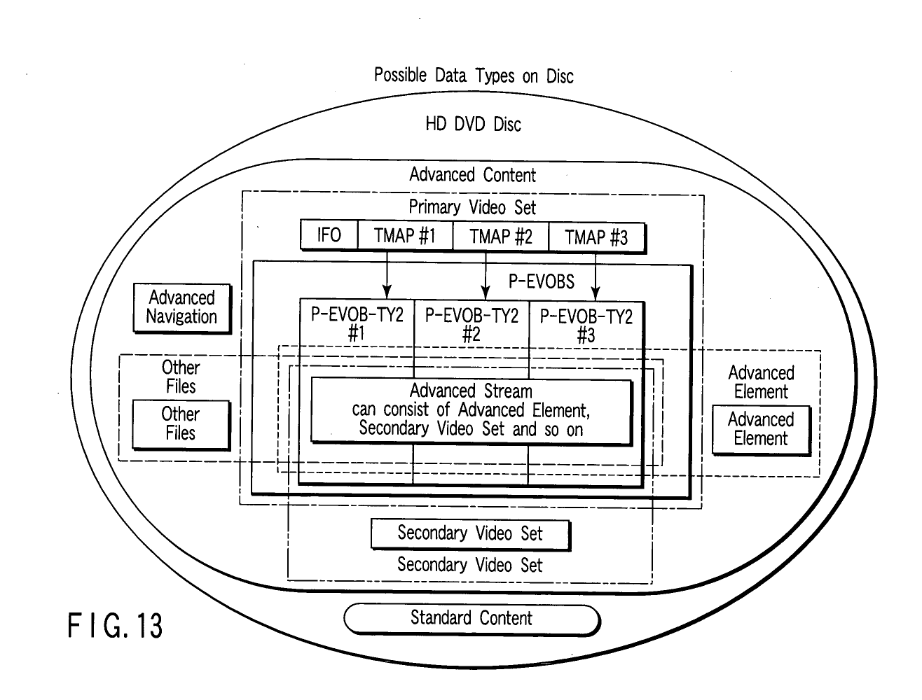

FIG. 13 shows data types that can be stored on an HD DVD disc. The disc can store both of the advanced content and the standard content. Available data types of the advanced content include: an Advanced Navigation, Advanced Elements, a Primary Video Set, a Secondary Video Set and the like.

FIG. 13 shows exemplary data types on a disc. An Advanced Stream is a data format for archiving any type of advanced content file excluding a Primary Video Set. The Advanced Stream is multiplexed to a Primary Enhanced Video Object Type 2 (P-EVOBS-TY2), and then, is drawn together with P-EVOBS-TY2 data supplied to a primary video player.

The same file that is archived in the Advanced Stream and that is mandatory for advanced content playback needs to be stored as a file. These copies guarantee advanced content playback. This is because advanced stream supply may not be completed when playback of the Primary Video Set jumps. In this case, necessary files are directly read from a disc to Data Cache before restarting playback from a designated jump position.

Advanced Navigation: An Advanced Navigation file is located as a file. The Advanced Navigation file is read between startup sequences, and then, the read file is interpreted for advanced content playback.

Advanced Elements: Advanced Elements can be located as a file and can be archived in an Advanced Stream multiplexed to P-EVOB-TY2.

Primary Video Set: Only one Primary Video Set exists on a disc.

Secondary Video Set: A Secondary Video Set can be located as a file and can be archived in an Advanced Stream multiplexed to P-EVOB-TY2.

Other Files: Other files may exist depending on an Advanced Content.

<Data Type on Network Server and Persistent Storage>

All of the Advanced Content files excluding a Primary Video Set can be placed on a network server and a persistent storage. An Advanced Navigation can copy a file stored on the network server or Persistent Storage to a File Cache, using correct API. A Secondary Video Player can read a Secondary Video Set from a network server or persistent storage into a streaming buffer. The Advanced Content file excluding the Primary Video Set can be stored in the Persistent Storage.

<Details of Advanced Content Player Model>

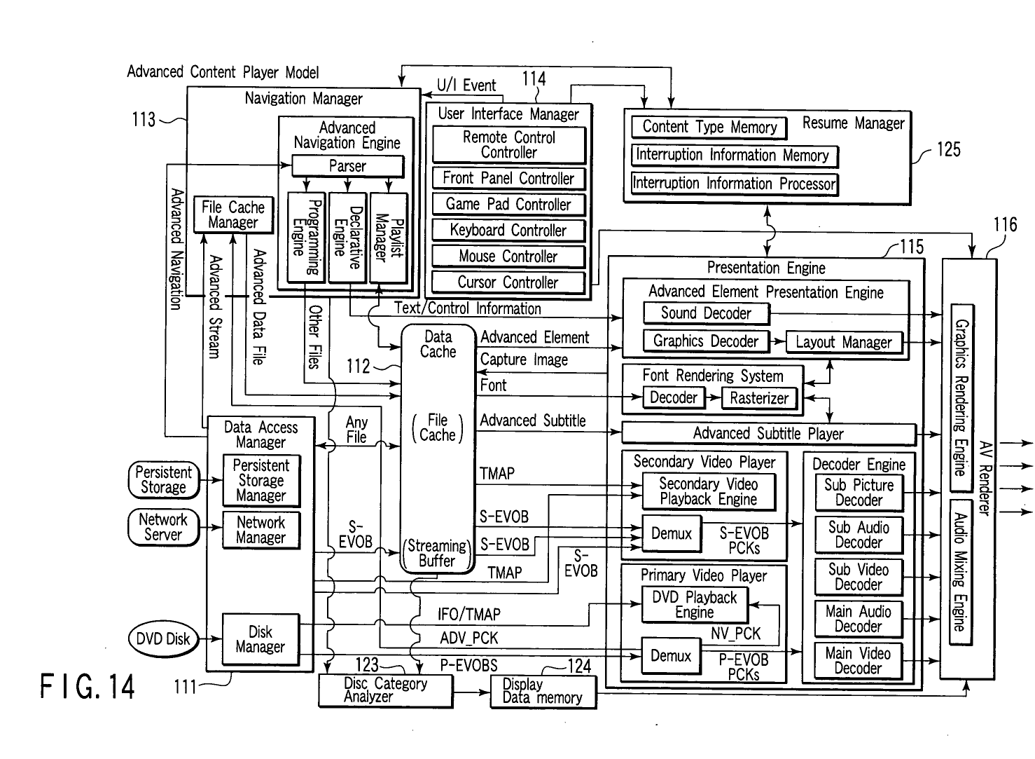

FIG. 14 shows an Advanced Content Player Model in detail.

An Advanced Content Player is a logical player for advanced contents. Advanced content data sources include: a Disc 131, a Network Server 132, and a Persistent Storage 133. The Advanced Content Player is compatible with these data sources.

Any data type of advanced contents can be stored on the disc. With respect to the Advanced Contents for the Persistent Storage and the Network Server, any data type excluding the Primary Video Set can also be stored.

A user event entry is made by a user input device such as a remote controller or a front panel of an HD DVD player. The Advanced Content Player is responsible for entry of user events into the Advanced Contents and generation of a correct response. Audio and video outputs are sent to a speaker and a display device, respectively.

The Advanced Content Player is a logical player for advanced contents. This player primarily comprises six logical function modules, i.e., a Data Access Manager 111; a Data Cache 112; a Navigation Manager 113; a User Interface Manager 114 serving as a command section; a Presentation Engine 115; and an AV Renderer 116. These elements form a playback processing section, and include a reproducing section, a command section, and a playback control section.

Further, the player has a Disc Category Analyzer 123 and a Display Data Memory 124. The Disc Category Analyzer 123 judges category of a currently mounted disc based on information and commands acquired in the Data Cache 112 and the Navigation Manager 113. In addition, when the routine reverts from an Advanced Content playback state to a Standard Content playback state or vice versa while the disc of category 3 is mounted, its state can be sensed.

Furthermore, a Resume Manager 125 is provided. The layout location of this Resume Manager 125 is not limited to the illustrated location, and, for example, may be provided in the Presentation Engine 115 or the Navigation Manager 113. The Resume Manager 125 executes operations as shown in FIGS. 7, 8, and 9 together with the Disc Category Analyzer 123. The Resume Manager 125 includes at least a Content Type Memory 125a, an Interruption Information Memory 125b, and an Interruption Information Processing Section 125c.

The Content Type Memory 125a is a content type storage section capable of determining a type (standard or advanced) of contents of a disc in playback, and then, storing content determination information. The interruption information memory 125b is an interruption information storage section for, when playback interruption occurs during disc playback, storing information relating to a playback position contained in management information. The interruption information processing section 125c determines information contained in the content type storage section when playback interruption occurs during disc playback; stores the information relating to the playback position in the interruption information storage section when the content is of a first type; and aborts the information relating to the playback position when the content is of a second type.

The above playback processing section sets an initial playback state of contents when a reproducing operation occurs after playback interruption has occurred, and the disc has stored therein advanced contents. In addition, the playback processing section sets a disc playback state based on information relating to the playback position of the interruption information storage section when the disc has stored therein only standard contents.

Then, a Data Access Manager 111 in a playback processing section can determine its operation based on storage information contained in the Resume Manager 125. This operation includes reading disc or external memory playlist, for example.

<Data Access Manager>

A Data Access Manager is composed of a Disc Manager, a Network Manager, and a Persistent Storage Manager. A Data Access Manager 111 is responsible for exchange of a various types of data between a Data Source and an internal module of an Advanced Content Player.

A Data Cache 112 is a temporary data storage for playback advanced contents.

Persistent Storage Manager: A Persistent Storage Manager controls exchange of data between a persistent storage device and a module inside an advanced content player. The Persistent Storage Manager is responsible for provision of a file access API set relevant to the Persistent Storage Device. The Persistent Storage Device can support a file read/write function.

Network Manager: A Network Manager controls exchange of data between a Network Server and a module inside an Advanced Content Player. The Network Manager is responsible for provision of a file access API set relevant to the Network Server. The Network Server can generally support file downloading and support file uploading, depending on the Network Server. A Navigation Manager can execute file downloading/uploading between the Network Server and a File Cache in accordance with Advanced Navigation. In addition, the Network Manager can also provide an access function at a protocol level with respect to a Presentation Engine. A Secondary Video Player in the Presentation Engine can utilize these API sets for streaming from the Network Server.

<Data Cache>

A Data Cache has two types of temporary data storages. One is a File Cache that is a temporary buffer for file data. The other is a Streaming Buffer that is a temporary buffer for streaming data. Allocation of streaming data in the Data Cache is described in “Playlist00. xml”, and is divided using a startup sequence for advanced content playback. The size of the Data Cache is 64 MB at minimum and is undefined at maximum.

Data Cache Initialization: A configuration of the Data Cache is changed using the startup sequence for advanced content playback. The size of the Streaming Buffer can be described in “Playlist00. xml”. In the case where there is no description of the Streaming Buffer size, it denotes that the size of the Streaming Buffer is zero. The byte number of the Streaming Buffer size is calculated as follows.

<streamingBuf size=“1024”/>

Streaming Buffer size=1024×2 (KByte)=2048 (KByte)

The Streaming Buffer is zero byte at minimum and is undefined at maximum.

File Cache: A File Cache is used as a temporary file cache between Data sources or a Navigation Engine and a Presentation Engine. Advanced content files such as graphics images, effect sounds, texts, and fonts need to be stored in the File Cache before access from the Navigation Manager or an Advanced Navigation Engine.

Streaming Buffer: A Streaming Buffer is used as a temporary data buffer for a Secondary Video Set by means of a Secondary Video Playback Engine of a Secondary Video Player.

The Secondary Video Player requests the Network Manager to acquire part of a Secondary Video Set S-EVOB in the Streaming Buffer. The Secondary Video Player reads the S-EVOB data from the Streaming Buffer, and then, provides the read data to a Demultiplexer Module (Demux) of the Secondary Video Player.

<Navigation Manager>

A Navigation Manager 113 is responsible for control of all functional modules of the advanced Content Player in accordance with the description in the Advanced Navigation.

The Navigation Manager is mainly composed of two types of functional modules, an Advanced Navigation Engine and a File Cache Manager.

Advanced Navigation Engine: An Advanced Navigation Engine controls all of reproducing operations of advanced contents and controls an Advanced Presentation Engine in accordance with the Advanced Navigation. The Advanced Navigation Engine includes a Parser, a Declarative Engine, and a Programming Engine.

Parser: A Parser reads advanced navigation files and analyzes the syntax thereof. A result of the analysis is sent to proper modules, the declarative engine and the programming engine.

Declarative Engine: A declarative engine manages and controls operations whose advanced contents are declared, in accordance with the Advanced Navigation. The Declarative Engine carries out the following processing operations, namely:
The Declarative Engine makes controls of the Advanced Presentation Engine. Namely, it carries out:
Layout of a graphics object and an advanced text;
Styling of a graphics object and an advanced text; and
Timing control of a scheduled graphics plane operation and effect sound playback, and the like.
The Declarative Engine makes control of a Primary Video Player. Namely, it carries out:
Configuring a Primary Video Set including registry of a title playback sequence (Title Time Line); and
Control of a high-level player.
The Declarative Engine makes control of a Secondary Video Player. Namely, it carries out:
Configuring a Secondary Video Set; and
Control of a high-level player, and the like.

Programming Engine: A Programming Engine manages event driven behaviors, API (application Interface) set call, or all advanced contents. A user interface event is generally handled by the Programming Engine, and thus, an operation of the Advanced Navigation defined by the Declarative Engine may be changed.

File Cache Manager: A File Cache Manager carries out the following processing operations:
Providing files archived in an advanced stream of P-EVOBS from a demultiplexer module of the Primary Video Player;
Providing the Network Server or Persistent Storage with archived files;
Managing a survival period of files in the File Cache; and
Acquiring a file in the case where the file requested from the Advanced Navigation or the Presentation Engine has not been stored in the File Cache.

The above File Cache Manager is composed of an ADV_PCK buffer and a file extractor.

ADV_PCK Buffer: A File Cache Manager receives PCK of the advanced stream archived in P-EVOBS-TY2 from a demultiplexer module of a Primary Video Player. A PS header of the advanced stream PCK is erased, and basic data is stored in an ADV_PCK Buffer. In addition, the File Cache Manager acquires again an advanced stream file of the Network Server or Persistent Storage.

File Extractor: A File Extractor extracts an archived file from an advanced stream into an ADV_PCK buffer. The thus extracted file is stored in the File Cache.

<Presentation Engine>

A Presentation Engine 115 is responsible for playback of materials for presentation such as Advanced Elements, a Primary Video Set, and a Secondary Video Set.

The Presentation Engine decodes presentation data, and outputs an AV Renderer using a navigation command from the Navigation Engine. The Presentation Engine includes four types of modules, an Advanced Element Presentation Engine, a Secondary Video Player, a Primary Video Player, and a Decoder Engine.

Advanced Element Presentation Engine: An Advanced Element Presentation Engine outputs two types of presentation streams to an AV Renderer. One is a frame image of a graphics plane and the other is an effect sound stream. The Advanced Element Presentation Engine is composed of a Sound Decoder, a Graphics Decoder, a Text/Font Rasterizer or a Font Rendering System, and a Layout Manager.

Sound Decoder: A Sound Decoder reads a WAV file from a File Cache, and then, outputs LPCN data to an AV Renderer started up by the Navigation Engine.

Graphics Decoder: A Graphics Decoder acquires graphics data such as a PNG image or a JPEG image from a File Cache. These image files are decoded, and then, the decoded image files are sent to a Layout Manager upon request from the Layout Manager.

Text/Font Rasterizer: A Text/Font Rasterizer acquires font data from a File Cache, and then, generates a text image. In addition, this Rasterizer receives text data from a Navigation Manager or the File Cache. The text image is generated, and then, the generated text image is sent to the Layout Manager upon request from the Layout Manager.

Layout Manager: A Layout Manager produces a frame image of a graphics plane with respect to an AV Renderer. When the frame image is changed, layout information is sent from a Navigation Manager. The Layout Manager calls a graphics decoder, and then, decodes a specific graphics object set on the frame image. In addition, the Layout Manager calls a Text/Font Rasterizer, and then, produces a specific text object set on the frame image similarly. The Layout Manager locates a graphical image from a bottom layer to an appropriate place, and then, calculates a pixel value in the case where an object has an alpha channel or a value. Lastly, the frame image is sent to the AV Renderer.

Advanced Subtitle Player: An Advanced Subtitle Player includes a Timing Engine and a Layout Engine.

Font Rendering System: A Font Rendering System has a Font Engine, a Scaler, an Alphamap Generation, and a Font Cache.

Secondary Video Player: A Secondary Video Player plays subsidiary video contents, subsidiary audios, and subsidiary subtitles. These subsidiary presentation contents are generally stored in a disc, a network, and a persistent storage. In the case where contents are stored in the disc and not stored in a File Cache, an access cannot be provided from the Secondary Video Player. In the case of an access from a Network Server, it is necessary to immediately store contents in a Streaming Buffer before they are provided to a demultiplexer/decoder and avoid a data loss due to a bit rate change in a network transfer path. The Secondary Video Player is composed of a Secondary Video Playback Engine and a Demultiplexer Secondary Video Player. The Secondary Video Player is connected to an appropriate decoder of a Decoder Engine in accordance with a stream type of the Secondary Video Set.

Since two audio streams cannot be simultaneously stored in the Secondary Video Set, only one audio decoder is always connected to the Secondary Video Player.

Secondary Video Playback Engine: A Secondary Video Playback Engine controls all functional modules of a Secondary Video Player upon request from a Navigation Manager. The Secondary Video Playback Engine reads and analyzes a TMAP file, and grasps an appropriate read position of S-EVOB.

Demultiplexer (Dmux): A Demultiplexer reads an S-EVOB stream, and then, sends the read stream to a decoder connected to the Secondary Video Player. In addition, the Demultiplexer outputs PCK of S-EVOB at an SCR timing. In the case where S-EVOB is composed of any one stream of videos, audios, and advanced subtitles, the demultiplexer provides it to the decoder at an appropriate SCR timing.

Primary Video Player: A Primary Video Player plays a Primary Video Set. The Primary Video Set must be stored in a disc. The Primary Video Player is composed of a DVD Playback Engine and a Demultiplexer. The Primary Video Player is connected to an appropriate decoder of a Decoder Engine in accordance with a stream type of a Primary Video Set. In addition, playback of standard contents is executed in accordance with an operating mode.

DVD Playback Engine: A DVD Playback Engine controls all of functional modules of a Primary Video Player upon request from a Navigation Manager. The DVD Playback Engine reads and analyzes IFO and TMAP and controls special playback functions for a Primary Video Set such as grasping of an appropriate read position of P-EVOBS-TY2, multi-angle or audio/sub-picture selection, and sub video/audio playback.

Demux: A Demultiplexer reads P-EVOBS-TY2 in a DVD Playback Engine, and sends it to an appropriate decoder connected to a Primary Video Set. In addition, the Demultiplexer outputs each PCK of P-EVOB-TY2 to each decoder at an appropriate SCR timing. In the case of a multi-angle stream, an appropriate interleaved block of P-EVOB-TY2 on a disc is read in accordance with positional information of TMAP or Navigation Pack (N_PCK). The Demultiplexer provides an appropriate number of an audio pack (A_PCK) to a Main Audio Decoder or a Sub Audio Decoder and provides an appropriate number of a sub-picture pack (SP_PCK) to an SP Decoder.

Decoder Engine: A Decoder Engine consists of six types of decoders, i.e., a timed text decoder, a sub-picture decoder, a sub audio decoder, a sub video decoder, a main audio decoder, and a main video decoder. Each decoder is controlled by means of a playback engine of a connected player.

Timed Text Decoder: A Timed Text Decoder can be connected to only a demultiplexer module of a Secondary Video Player. This Decoder decodes an advanced subtitle of a format based on the timed text upon request from a DVD Playback Engine. One decoder can be made active at the same time between the Timed Text Decoder and the Sub-Picture Decoder. An output graphics plane is called a sub-picture plane, and is shared by outputs from the Timed Text Decoder and the Sub-Picture Decoder.

Sub Picture Decoder: A Sub-Picture Decoder can be connected to a demultiplexer module of a Primary Video Player. Sub-Picture data is decoded upon request from the DVD Playback Engine. One decoder can be made active at the same time between the Timed Text Decoder and the Sub-Picture Decoder. An output graphics plane is called a sub-picture plane, and is shared by outputs from the Timed Text Decoder and the Sub-Picture Decoder.

Sub Audio Decoder: A Sub Audio Decoder can be connected to demultiplexer modules of a Primary Video Player and a Secondary Video Player. The Sub Audio Decoder can support audios up to 2 channels and a sampling rate up to 48 kHz. This is called a sub audio. The sub audio is supported as a sub audio stream of the Primary Video Set, a stream of only audio of the Secondary Video Set, and further, an audio/video multiplexer stream of the Secondary Video Set. An output audio stream of the Sub Audio Decoder is called a sub audio stream.

Sub Video Decoder: A Sub Video Decoder can be connected to demultiplexer modules of a Primary Video Player and a Secondary Video Player. The Sub Video Decoder can support an SD resolution video stream called a sub video (maximum support resolution in preparation). The sub video is supported as a video stream of the Secondary Video Set and as a sub video stream of the Primary Video Set. An output video plane of the sub video decoder is called a sub video plane.

Main Audio Decoder: A Primary Audio Decoder can be connected to demultiplexer modules of a Primary Video Player and a Secondary Video Player. The Primary Audio Decoder can support an audio up to 7.1 multi-channels and a sampling rate up to 96 kHz. This is called a main audio. The main audio is supported as a main audio stream of the Primary Video set and as a stream of an only audio of the Secondary Video Set. An output audio stream of the main audio decoder is called a main audio stream.

Main Video Decoder: A Main Video Decoder is connected to only a demultiplexer of a Primary Video Player. The Main Video Decoder can support an HD resolution video stream. This is called a support main video. The main video is supported only in the Primary Video Set. An output video plane of the Main Video Decoder is called a main video plane.

<AV Renderer> An AV Renderer 116 is responsible for mixing of video/audio inputs from another module and speaker or display output to an external device.

The AV Renderer has two roles. One is a Presentation Engine and the other is an Interface Manager. Further, this Manager acquires a graphics plane from an output mixing video signal and acquires a PCM stream from a Presentation Engine and an output mixing audio signal. The AV Renderer is composed of a Graphic Rendering Engine and a Sound Mixing Engine.

Graphic Rendering Engine: A Graphic Rendering Engine acquires four graphics planes from a Presentation Engine and one graphics frame from a User Interface. The Graphics Rendering Engine combines these five planes with each other in accordance with control information acquired from a Navigation Manager, and then, outputs the thus combined video signals.

Audio Mixing Engine: An Audio Mixing Engine can acquire three LPCM streams from a Presentation Engine. A Sound Mixing Engine combines these three LPCM streams with one another in accordance with mixing level information acquired from a Navigation Manager, and then, outputs the combined audio signals.

<User Interface Manager>

A User Interface Manager 114 is responsible for control of a user interface device such as a remote controller or a front panel of an HD DVD player, and notifies a user entry event to a Navigation Manager 113.

The User Interface Manager, as shown in FIG. 14, includes a Font Panel Controller, a Remote Control Controller, a Keyboard Controller, a Mouse Controller, and a Game Pad Controller. Further, this Manager includes Device Controller of some user interfaces such as a Cursor Controller. Each controller checks whether or not a device is available and monitors a user-operated event. The user input event is notified to an event handler of a Navigation Manager.

The Cursor Manager controls a shape and a position of a cursor. A cursor plane is updated in accordance with a move event from an associated device such as a mouse or a game panel.

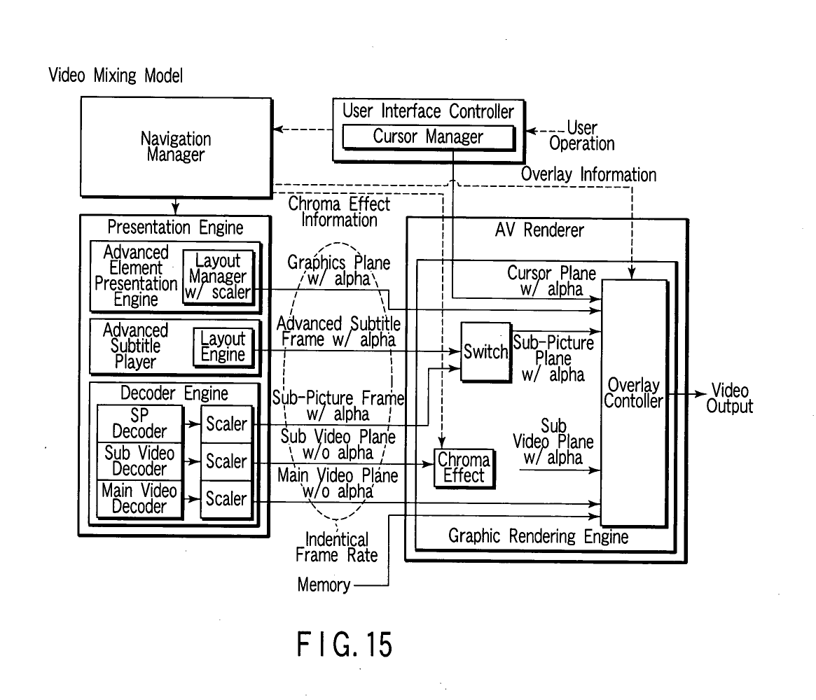

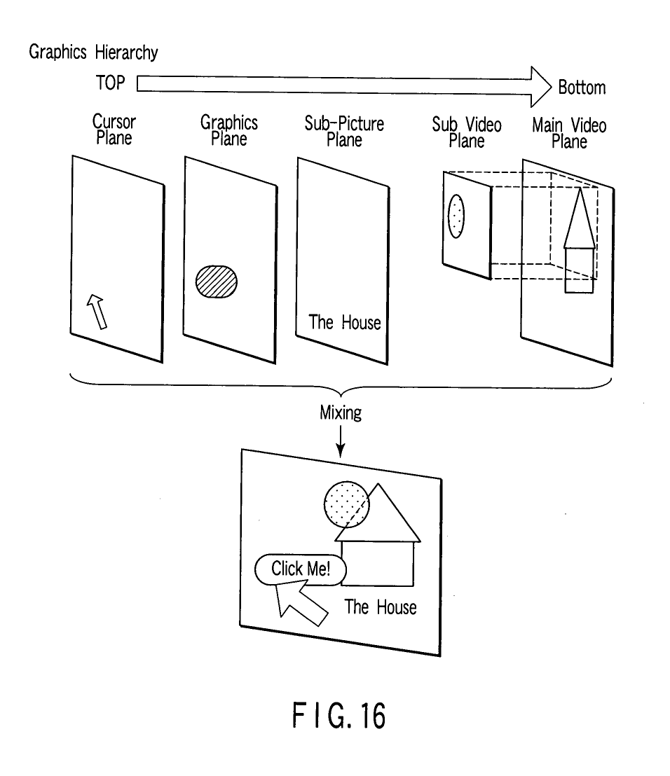

Video Mixing Model and Graphics Plane: A video-mixing model is shown in FIG. 15, and hierarchy of a graphics plane is shown in FIG. 16.

Five graphics can be inputted to this model shown in FIG. 15. These graphics are a Cursor Plane, a Graphics Plane, a Sub-Picture Plane, a Sub Video Plane, and a Main Video Plane.

Cursor Plane: A Cursor Plane is a top-layered plane among five graphics that are inputs to a Graphics Rendering Engine at the model. The Cursor Plane is generated by means of a Cursor Manager of the User Interface Manager. The Navigation Manager can replace the Cursor Image in accordance with Advanced Navigation. The Cursor Manager moves a cursor to an appropriate position of the Cursor Plane, and then, updates the moved cursor with respect to the Graphics Rendering Engine. The Graphics Rendering Engine acquires its cursor plane and alpha mix, and then, lowers a plane in accordance with alpha information acquired from the Navigation Engine.

Graphics Plane: A Graphics Plane is a second plane among the five graphics that are inputs to the Graphics Rendering Engine at the model. The Graphics Plane is generated by means of an Advanced Element Presentation Engine in accordance with the Navigation Engine. A Layout Manager produces a Graphics Plane by using a Graphics Decoder and a Text/Font Rasterizer. The size and rate of an output frame must be equal to those of a video output of this model. An animation effect can be realized by means of a series of graphics images (cell animation). Alpha information relevant to the plane is not provided from a Navigation Manager of an overlay controller. These values are provided to an alpha channel of a Graphics Plane per se.

Sub-Picture Plane: A Sub-Picture Plane is a third plane among the five graphics that are inputs to the Graphics Rendering Engine at the model. The Sub-Picture Plane is generated by means of a Timed Text Decoder or a Sub-Picture Decoder of a Decoder Engine. In a Primary Video Set, a set of appropriate sub-picture images can be inputted in output frame size. In the case where an appropriate size of an SP image is identified, an SP Decoder directly transmits the generated frame image to the Graphics Rendering Engine. In the case where the appropriate size of the SP image is not identified, a Scaler that follows the SP Decoder measures the appropriate size and position of the frame image, and then, transmits the measurement to the Graphics Rendering Engine.

A Secondary Video Set can enter an advanced subtitle for the Timed Text Decoder. Output data from the Sub-Picture decoder holds alpha channel information.

Sub Video Plane: A Sub Video Plane is a fourth plane among the five graphics that are inputs to the Graphics Rendering Engine at the model. The Sub Video Plane is generated by means of a Sub Video Decoder of a Decoder Engine. The Sub Video Plane is measured by means of a Scaler of the Decoder Engine in accordance with information acquired from a Navigation Manager. An output frame rate must be equal to that of a final video output. Cutting of an object shape of the Sub Video Plane is carried out by means of a chroma effect module of the Graphics Rendering Engine as long as information is provided. Chroma color (or range) information is provided from the Navigation Manager in accordance with Advanced Navigation. An output plane from the chroma effect module has two alpha values. One is 100%-visible and the other is 100%-transparent. With respect to overlay on a bottom-layered Main Video Plane, an intermediate alpha value is provided from the Navigation Manager, and then, such overlay is carried out by means of an overlay control module of the Graphics Rendering Engine.

Main Video Plane: A Main Video Plane is a bottom-layered plane among the five graphics that are inputs to the Graphics Rendering Engine at the model. The Main Video Plane is generated by means of a Main Video Decoder of a Decoder Engine. The Main Video Plane is measured by means of a Scaler of a Decoder Engine in accordance with information acquired from a Navigation Manager. An output frame rate must be equal to that of a final video output. In the case where the Navigation Manager carries out measurement in accordance with Advanced Navigation, an outside frame color can be set for the Main Video Plane. A default color value of the outside frame is “0, 0, 0” (=black).

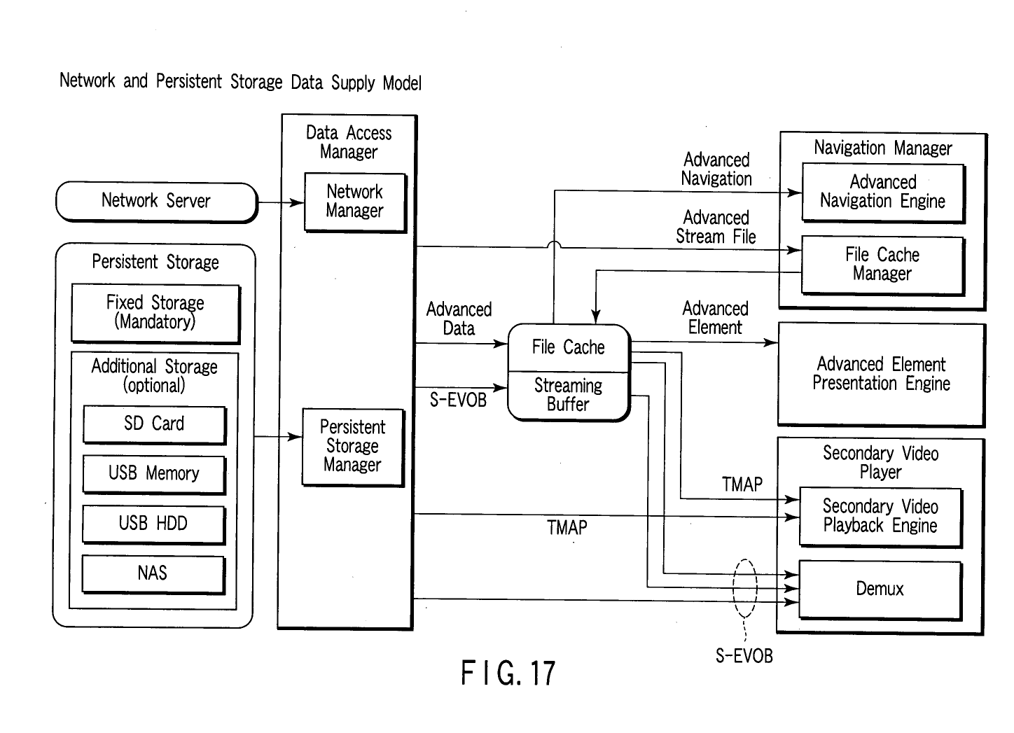

As described above, in the Advanced Player, in accordance with object mapping of a playlist, an object selected by a video audio clip and included in this clip is played back while a timeline is defined as a time base. Namely, in the case where a first application includes Primary/Secondary Video Sets or the like in accordance with a description of a playlist, this application is executed while referring thereto. One application is composed of a manifest, a markup (including contents/styling/timing information), a script, and advanced data. A first one markup file, a script file, and other resources, which configure an application, are referenced in one manifest file. By means of a markup, playback of advanced data such as primary/secondary video sets and advanced elements is started.

<Network and Persistent Storage Data Supply Model (FIG. 17)>

A Network and Persistent Storage Data Supply Model of FIG. 17 represents a data supply model of advanced contents from a network server and a persistent storage.

The Network and Persistent Storage can store all of advanced content files other than a Primary Video Set. The Network Manager and the Persistent Storage Manager each provide a file access function. In addition, the Network Manager also provides an access function at a protocol level.

A File Cache Manager of a Navigation Manager can acquire an advanced stream file (archive format) directly from the Network Server and the Persistent Storage via a Network Manager and a Persistent Storage Manager. The Advanced Navigation Engine cannot directly access the Network Server or the Persistent Storage. Files must be immediately stored in a File Cache before the Advanced Navigation Engine reads them.

The Advanced Element Presentation Engine can process a file that exists in the Network Server or the Persistent Storage. The Advanced Element Presentation Engine calls a File Cache Manager, and then, acquires a file that it not placed in the File Cache. The File Cache Manager is compared with a File Cache Table to check whether or not a requested file is cached in the File Cache. In the case where the file has exited in the File Cache, the File Cache Manager directly posts the file data to the Advanced Presentation Engine. In the case where the file has not existed in the File Cache, the File Cache Manager acquires a file from an original place to the File Cache, and then, posts the file data to the Advanced Presentation Engine.

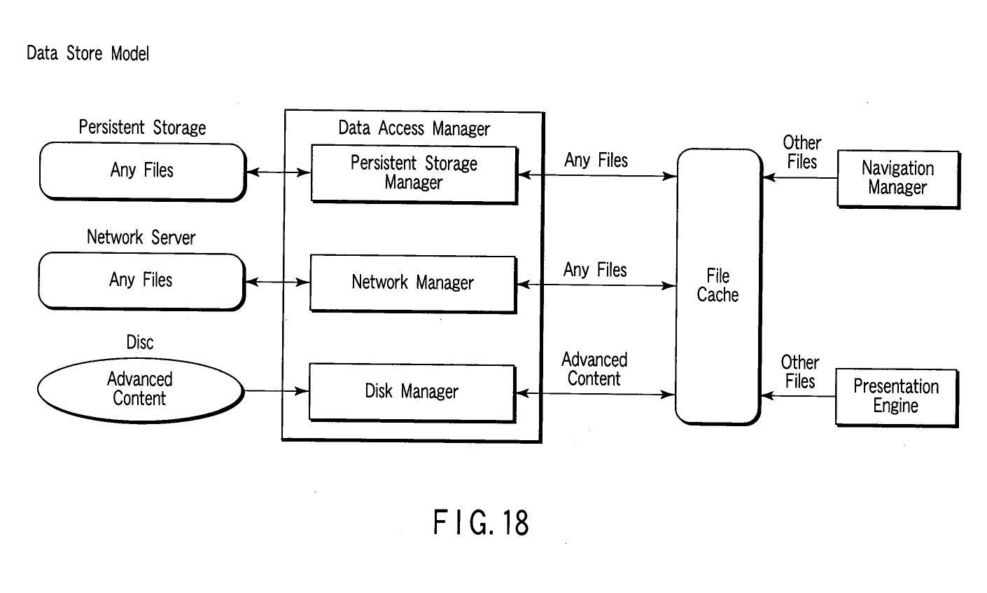

A Secondary Video Player acquires a secondary video set file such as TMAP or S-EVOB from a Network Server and a Persistent Storage via a Network Manager and a Persistent Storage Manager, as is the case with the File Cache. In general, a Secondary Video Playback Engine acquires S-EVOB from a Network Server by using a streaming buffer. Immediately, part of S-EVOB data is stored in a streaming buffer, and is provided to a demultiplexer module of the Secondary Video Player.

<Data Store Model (FIG. 18)>

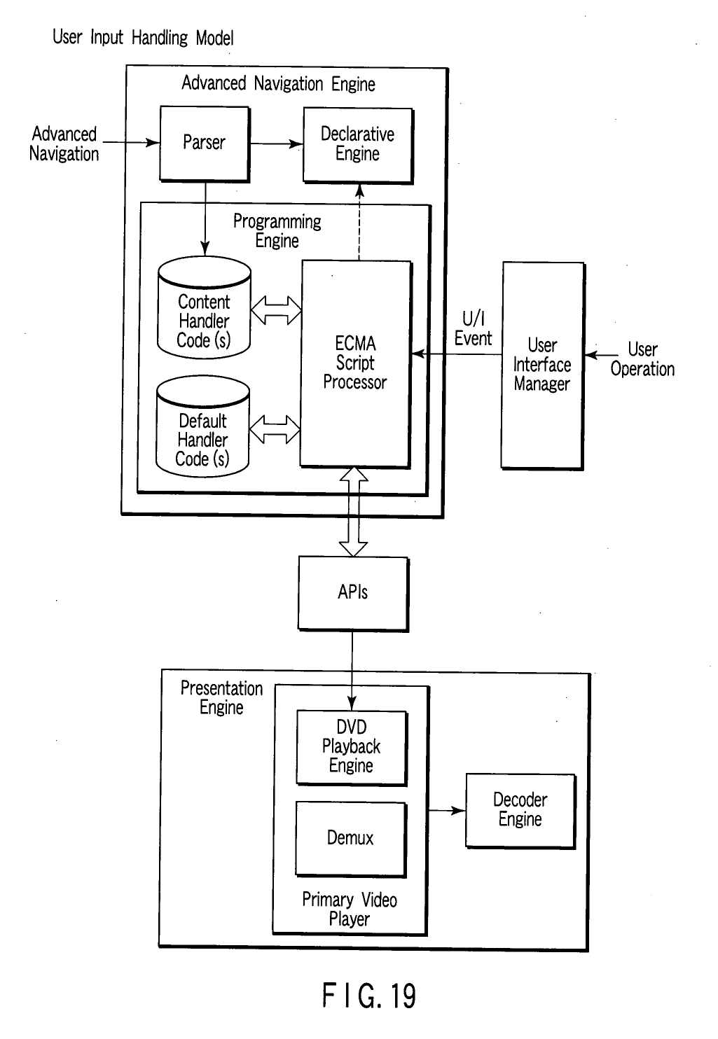

FIG. 18 explains a Data Store Model. There are two types of data storages, i.e., Persistent Storage and a Network Server. Two types of files are generated at the time of advanced content playback. One is a file of an exclusive type that is generated by means of a Programming Engine of a Navigation Manager. A format is different from another format depending on a description of the Programming Engine. The other file is an image file that is acquired by means of a Presentation Engine.

<User Input Model (FIG. 19)>

All of user input events shown in FIG. 19 are handled by means of a Programming Engine. A user operation via a user interface device such as a remote controller or a front panel is first inputted to a User Interface Manager. The User Interface Manager converts input signals for each player into an event defined as “UIIEvent” of “InterfaceRemoteControllerEvent”. The converted user input event is transmitted to a Programming Engine.

The Programming Engine has an ECMA Script Processor, and executes a programmable operation. The programmable operation is defined by means of a description of an ECMA Script provided by a Script File of Advanced Navigation. The user event handler code defined in a script file is registered in the Programming Engine.

When the ECMA script processor receives a user input event, the ECMA script processor checks whether or not the handler code corresponds to a current event registered in a content handler code. In the case where registration occurs, the ECMA script processor executes it. In the case where no registration occurs, the ECMA script processor makes a search for a default handler code. In the case where the corresponding default handler code exists, the ECMA script processor executes it. In the case where it does not exist, the ECMA script processor cancels that event or outputs a warning signal.

<Presentation Timing Model>

An Advanced Content Presentation is managed by a master time for defining a synchronization relationship between a presentation schedule and a presentation object. The master time is called a title timeline. This title timeline is defined for each logical playback time, and the defined timeline is called a title. A timing unit of the title timeline is 90 kHz. There are five types of presentation objects, i.e., a Primary Video Set (PVS), a Secondary Video Set (SVS), a Subsidiary Audio, a Subsidiary Subtitle, and an Advanced Application (ADV_APP).

<Presentation Object>

Five types of presentation objects are as follows:
Primary Video Set (PVS)
Secondary Video Set (SVS)
Sub Video/Sub Audio
Sub Video
Sub Audio
Subsidiary Audio (for Primary Video Set)
Subsidiary Subtitle (for Primary Video Set)
Advanced Application (ADV_APP)

<Attributes of Presentation Object>

A Presentation Object has two types of attributes. One is “an object that is scheduled or not scheduled” and the other is “an object that is synchronized or not synchronized”.

<Scheduled and Synchronized Presentation Object>

Start and end times of this object type are allocated in advance to a playlist file. A Presentation Timing is synchronized with a time of a Title Timeline. A Primary Video Set, a Subsidiary Audio, and a Subsidiary Subtitle are of this object type. A Secondary Video Set and an Advanced Application are handled as this object type.

<Scheduled and Non-Synchronized Presentation Object>

The start and end times of this object type are allocated in advance to a playlist file. A presentation timing is a time base of its own. A Secondary Video Set and an Advanced Application are handed as this object type.

<Non-Scheduled and Synchronized Presentation Object>

This object type is not described in a playlist file. This object is started up by a user event handled by an Advanced Application. A presentation timing is synchronized on a title timeline.

<Non-Scheduled and Non-Synchronized Presentation Object>

This object type is not described in a playlist file. This object is started up by a user event handled by an Advanced Application. A presentation timing is a time base of its own.

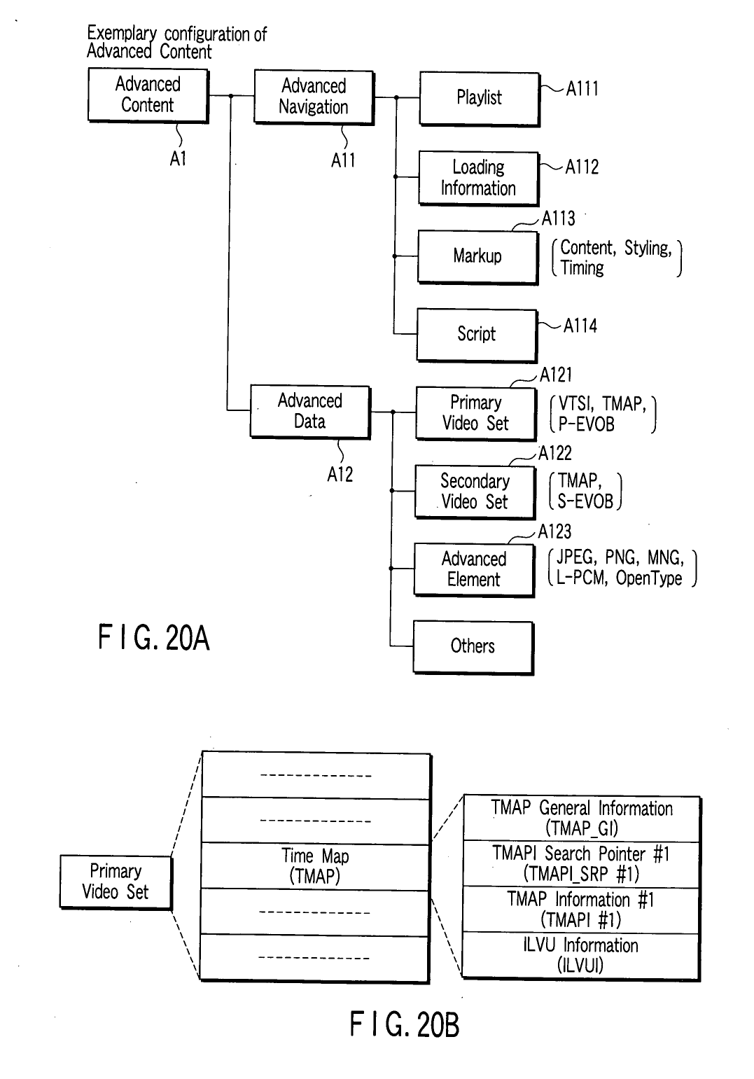

FIG. 20A is a diagram to help explain an exemplary configuration of an Advanced Content stored in an advanced content recording region of an information storage medium. The Advanced Content does not always need to be stored in the information storage medium, and, for example, may be provided from a server via a network.

As shown in FIG. 20A, the Advanced Content recorded in an advanced content area A1 is configured to include: an Advanced Navigation for managing Primary/Secondary Video Set outputs, test/graphic rendering, and an audio output; and Advanced Data made of these items of data managed by the Advanced Navigation. The Advanced Navigation recorded in an advanced navigation area A11 includes: playlist files, Markup files for content, styling, and timing information; and Script files. The playlist files are recorded in a playlist files area A111. Loading information files are recorded in a loading information files area A112. The Markup files are recorded in a markup files area A113. The Script files are recorded in a script files area A114.

The Advanced Data recorded in an advanced data area A12 includes: a Primary Video Set including object data (VTSI, TMAP, and P-EVOB); a Secondary Video Set including object data (TMAP and S-EVOB); and Advanced Elements (such as JPEG, PNG, MNG, L-PCM, OpenType font) and others. In addition, the Advanced Data also includes object data that configures a menu (screen) in addition to the above described elements. For example, the object data included in the Advanced Data is played back within a designated period on a timeline by means of a time map (TMAP) of a format shown in FIG. 20B. The Primary Video Set is recorded in a primary video set area A121. The Secondary Video Set is recorded in a secondary video set area A122. The Advanced Elements are recorded in an advanced element area A123.

The Advanced Navigation includes: playlist files, loading information files, markup files for content, styling, and timing information, and script files. These files (playlist files, loading information files, markup files, and scrip files) are encoded as an XML document. A resource of an XML document for the Advanced Navigation is rejected by means of an Advanced Navigation Engine when it is not described in a correct format.

While the XML document becomes valid in accordance with definition of a document type provided as standard, the Advanced Navigation Engine (at the player side) does not necessarily need a function of judging validity of the content (provider may guarantee the validity of the content.) When the resource of the XML document is not described in a correct format, normal operation of the Advanced Navigation Engine is not guaranteed.

Following rules are applied to XML declaration:
Encode declaration is “UTF-8” or “ISO-8859-1”. An XML file is encoded by means of either of them.
A value of standard document declaration in the XML declarations is set to “no” when this standard document declaration exists. When the standard document declaration does not exist, this value is handled as “no”.

All resources available on a disc or over a network have addresses encoded by a Uniform Resource Identifier defined by [URI, RFC2396].

A protocol and a path supported for a DVD disc are as follows, for example:

file://dvdrom:/dvd_advnav/file.xml

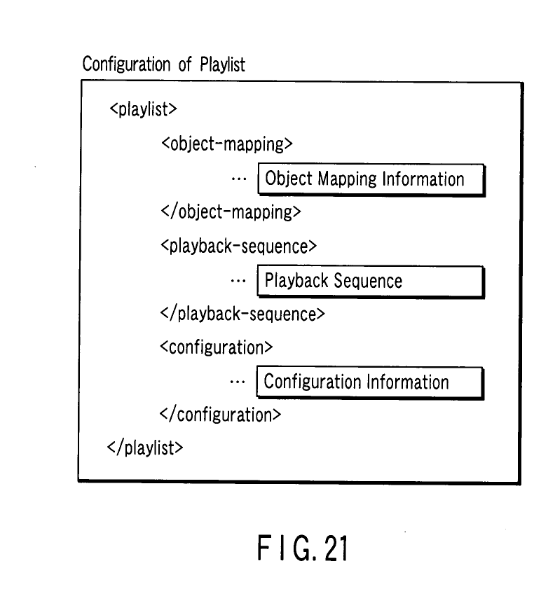

FIG. 20B shows an exemplary configuration of a time map (TMAP). This time map is used to convert a playback time in a primary enhanced video object (F-EVOB) to an address of the corresponding enhanced video object unit (EVOBU). The inside of TMAP comprising time map information (TMAPI) starts from TMAP General Information (TMAP_GI) followed by TMAPI Search Pointer (TMAPI_SRP) and TMAP Information (TMAPI), and finally, ILVU Information (ILVUI) is allocated.

<Playlist File (FIG. 21)>

A playlist file has two purposes of use relevant to advanced content playback. One is for initial system configuration of an HD DVD player and the other is for defining a method for playing a plurality of presentation contents of advanced contents.

In the playlist file, as exemplified in FIG. 21, sets of Object Mapping Information and Playback Sequences for titles are described on a title by title basis.
Object Mapping Information (Playback object information that exists in each title and is mapped on a timeline of this title);
Playback Sequence (playback information for each title described by a title timeline); and
Configuration Information (System configuration information such as data buffer alignment).

This playlist file is encoded in an XML format. The syntax of the playlist file can be defined by means of XML Syntax Representation.

This playlist file controls playback of a menu and a title composed of a plurality of objects, based on a time map for playing back the plurality of objects within a designated period on a timeline. This playlist enables playback of a dynamic menu.

According to a menu linked with the time map, dynamic information can be transmitted to a user. For example, a reduced playback screen (mobile picture) of chapters each configuring one title can be displayed on the menu linked with the time map, for example. In this manner, discrimination of chapters each configuring one title including a number of similar scenes is comparatively facilitated. Namely, according to the menu linked with the time map, multi-angled displays are enabled, and a complicated impressive menu display can be realized.

<Elements and Attributes>

A playlist element is a root element of that playlist. XML syntax representation of the Playlist element is as follows, for example:

<playlist>
Configuration TitleSet
</playlist>

The playlist element is composed of a Title Set element for a set of the information of Titles and a Configuration element for System Configuration Information. The Configuration element is composed of a set of System Configuration for Advanced Content. In addition, System Configuration Information can be composed of Data Cache configuration for specifying a stream buffer size or the like, for example.

The Title Set Element describes information of a set of Titles for Advanced Contents in the playlist. The XML Syntax Representation of the Title Set Element is as follows, for example.

<TitleSet>
Title*
</TitleSet>

The Title Set Element is composed of a list of Title elements. In accordance with a document sequence of title elements, Title numbers for the Advanced Navigation are assigned continuously sequentially from “1”. The Title Element is configured to describe information of each title.

That is, the Title Element describes information of Title for Advanced Contents configured to include object mapping information and playback sequences in a title. The XML Syntax Representation of the Title element is as follows, for example.

```
<Title
    id = ID
    hidden = (true | false)
    onExit = positiveInteger>
        Primary Video Track?
        SecondaryVideoTrack?
        SubstituteAudioTrack?
        ComplementarySubstituteTrack?
        ApplicationTrack*
        Chapter List?
</Title>
```

The content of the Title element is composed of an element fragment for tracks and a Chapter List element. Here, the element fragment for tracks is composed of: a list of elements of Primary Video Track; a Secondary Video Track; SubstituteAudio Track; a Complementary Subtitle Track; and an Application Track.

The Object Mapping Information for a Title is described by means of the element fragment for tracks. The mapping of a Presentation Object on a Title Timeline is described by mean of a corresponding element. Here, the Primary Video Set corresponds to the Primary Video Track; the Secondary Video Set corresponds to the Secondary Video Track; a SubstituteAudio corresponds to the SubstituteAudio Track; the Complementary Subtitle corresponds to the Complementary Subtitle Track; and ADV_APP corresponds to the Application Track.

The Title Timeline is assigned to each title. In addition, information of Playback Sequence for a Title made of chapter points is described by means of a Chapter List element.

Here, (a) hidden attribute can describe whether or not a title can be navigated by a user operation. If that value is “true”, that title cannot be navigated by the user operation. This value can be defaulted. In that case, the default value is set to “false”.

In addition, (b) on Exit attribute can describe a title played back after current title playback. When current title playback exists before the end of that title, a player can be configured not to carry out a (playback) jump.

A Primary Video Track element describes Object Mapping Information of the Primary Video Set in a title. The XML Syntax Representation of the Primary Video Track element is as follows, for example:

```
<Primary Video Track
    id = ID>
        (Clip | Clip Block) +
</Primary Video Track>
```

The content of the Primary Video Track is composed of a list of a Clip element and a Clip Block element, for referencing P-EVOB in the Primary Video as a Presentation Object. A player is configured to pre-assign P-EVOB(s) on a Title Timeline by using a start time and an end time in accordance with description of the Clip element. P-EVOB(s) assigned onto the Title Timeline are designed so as not to overlap each other.

The Secondary Video Track element describes Object Mapping Information of the Secondary Video Set in a title. The XML Syntax Representation of the Secondary Video Track element is as follows, for example:

```
<SecondaryVideoTrack
    id = ID
    sync = (true | false)>
        Clip +
</SecondaryVideoTrack>
```

The content of the Secondary Video Track is composed of a list of Clip elements, for referencing S-EVOB in the Secondary Video Set as a Presentation Object. A Player is configured so as to pre-assign S-EVOB(s) onto a Title Timeline by using a start time and an end time in accordance with description of the Clip element.

In addition, the Player is configured so as to map a Clip and the Clip Block onto the Time Timeline as start and end positions of a clip on the Title Timeline by means of a title Begin Time and a title End Time attribute of a clip element. S-EVOB(s) assigned onto the Title Timeline is designed so as not to overlap each other.

If a sync attribute is ‘true’, the Secondary Video Set is synchronized with a time on the Title Timeline. On the other hand, when the sync attribute is ‘false’, the Secondary Video Set can be configured to run in accordance with its own time. (In other words, when the sync attribute is ‘false’, playback proceeds in accordance with a time assigned to the Secondary Video Set per se instead of the time of the Timeline.)

Further, when a sync attribute value is ‘true’ or defaulted, the Presentation Object in the Secondary Video Track is obtained as a Synchronized Object. On the other hand, if the sync attribute value is ‘false’, the Presentation Object in the SecondaryVideoTrack is obtained as a Non-synchronized Object.

The SubstituteAudio Track element describes assignment to Audio Stream Number for the Object Mapping Information and Audio Stream Number of the Substitute Audio Track in a title. The XML Syntax Representation of the substitute audio track element is as follows, for example:

```
<SubstituteAudioTrack
    id = ID
    streamNumber = Number
        languageCode = token
        >
    Clip +
</SubstituteAudioTrack>
```

The content of the SubstituteAudioTrack element is composed of a list of clip elements, which refers to SubstituteAudio as a Presentation Element. A player is configured to pre-assign a SubstituteAudio onto a Title Timeline in accordance with description of the clip elements. The SubstituteAudios pre-assigned onto the Title Timeline is designed not to overlap each other.

A specified Audio Stream Number is assigned to the Substitute Audio. When Audio_stream_change API selects a specified stream number of the SubstituteAudio, the player is configured to select a SubstituteAudio instead of the audio stream in the Primary Video Set.

The audio stream number for this SubstituteAudio is described in a stream Number attribute.

A specific code and a specific code extension for this SubstituteAudio are described in a language Code attribute.

A language code attribute value conforms to the following scheme (BNF scheme). That is, the specific code and specific code extension describe a specific code and a specific code extension, respectively, and, for example, it follows:

```
    languageCode := specificCode ‘:’
specificCodeExtension
    specificCode := [A–Za–z] [A–Za–z0–9]
    specificCodeExt := [0–9A–F] [0–9A–F]
```

A Complementary Substitute Track element describes the Object Mapping Information on the Complementary Subtitle in a title and assignment to Sub-picture Stream Number. The XML Syntax Representation of the Complementary Subtitle Track element is as follows, for example.

```
<ComplementarySubtitleTrack
    id = ID
    streamNumber = Number
        languageCode = token
        >
    Clip +
</ComplementarySubtitleTrack>
```

The content of the Complementary Subtitle Track element is composed of a list of clip elements, which refers to a Complementary Subtitle as a Presentation Element. A player is configured to pre-assign the Complementary Subtitle on a Title Timeline in accordance with description of the clip elements. Complementary Subtitle(s) assigned onto the Title Timeline are designed not to overlap each other.

A specified Sub-picture Stream Number is assigned to the Complementary Subtitle. When Sub-picture_stream_Change API selects a stream number of the Complementary Subtitle, the player is configured to select the Complementary Subtitle instead of a sub-picture stream in a Primary Video Set.

A Sub-picture Stream Number for this Complementary Subtitle is described in a stream Number attribute.

A specific code and a specific code extension for this Complementary Subtitle are described in a language code attribute.

A language code attribute value conforms to the following scheme (BNF scheme). That is, the specific code and specific code extension describe a specific code and a specific code extension, respectively, and, for example, it follows:

languageCode:=specificCode‘:’ specificCodeExtension

specificCode := [A–Za–z] [A–Za–z0–9]
specificCodeExt := [0–9A–F] [0–9A–F]

An Application Track element describes object mapping information on ADV_APP in the title. An XML syntax representation of the Application Track element is, for example, as follows:

```
<ApplicationTrack
    id = ID
    loading_info = anyURI
    sync = (true | false)
    language = string />
```

Here, ADV_APP is scheduled on a whole Title Timeline. When a player starts title playback, the player launches ADV_APP in accordance with Loading Information file indicated by a loading information attribute. When the player exits the title playback, ADV_APP in a title is also terminated.

Here, if a sync attribute is ‘true’, ADV_APP is configured to be synchronized with a time on a Title Timeline. On the other hand, when the sync attribute is ‘false’, ADV_APP can be configured to run in accordance with its own time.

A loading information attribute describes URI for loading information files having described therein initialization information of the application.

With respect to a sync attribute, when the sync attribute value is ‘true’, it indicates that ADV_APP in ApplicationTrack is a Synchronized Object. On the other hand, if the sync attribute value is ‘false’, it indicates that ADV_APP in ApplicationTrack is a Non-synchronized Object.

A Clip Element describes information on a period (life period or from a start time to an end time) on a Title Timeline of a Presentation Object. The XML Syntax Representation of the Clip Element is as follows, for example:

```
    <Clip
        id = ID
        title Time Begin = time Expression
        clip Time Begin = time Expression
        title Time End = time Expression
        src = anyURI
        preload = time Expression
        xml:base = anyURI>
            (Unavailable Audio Stream |
Unavailable Sub picture Stream)*
        </Clip>
```

The life period on the Title Timeline of the Presentation Object is determined depending on a start time and an end time on the Title Timeline. The start time and end time on the Title Timeline can be described by a title Time Begin attribute and a title Time End attribute, respectively. A starting position of the Presentation Object is described by means of a clip Time Begin attribute. In the start time on the Title Timeline, the Presentation Object exists at a start position described by clip Time Begin.

The Presentation Object is referenced by means of URI of an index information file. A TMAP file for P-EVOB is referred to with respect to a Primary Video Set. A TMAP file for S-EVOB is referred to with respect to a Secondary Video Set. A TMAP file for S-EVOB of a Secondary Video Set including an Object is referred to with respect to a SubstituteAudio and a Complementary Subtitle.

Attribute values of a title Begin Time, a title End Time, clip Begin Time, and a duration time of a Presentation Object are configured to satisfy the following relationship:

```
    title Begin Time < title End Time and
    Clip Begin Time + title End Time − title
Begin Time
        ≦ duration time of Presentation
Object
```

An Unavailable Audio Stream and an Unavailable Sub picture Stream exist only for a Clip Element in a Preliminary Video Track element.

A title Time Begin attribute describes a start time of a continuous fragment of a Presentation Object on a Title Timeline.

A title Time End attribute describes an end time of a continuous fragment of a Presentation Object on a Title Timeline.

A clip Time Begin attribute describes a starting position in a Presentation Object, and the value thereof can be described in a time Expression value. The clip Time Begin can be defaulted. When the clip Time Begin attribute does not exist, the starting position is set to ‘0’, for example.

A “src” attribute describes URI of an index information file of a Presentation Object to be referred to.

A preload attribute can describe a time on a Title Timeline when starting playback of a Presentation Object pre-fetched by a player.

A Clip Block element describes a group of clips in P-EVOBS called a Clip Block. One clip is selected for playback. The XML Syntax Representation of the Clip Block element is as follows, for example:

<Clip Block>
Clip+
</Clip Block>

All clips in the Clip Block are configured so as to have the same start time and the same end time. From this fact, the Clip Block can be scheduled on a Title Timeline by using start and end times of the first child Clip. The Clip Block can be configured to be usable only in a Primary Video Track.

The Clip Block can express an Angle Block. In accordance with the document sequence of the Clip elements, Angle numbers for an Advanced Navigation are continuously assigned from “1”.

A player selects a first clip to be played back as a default. However, when Angle_Change API selects a specified Angle number, the player selects a clip corresponding thereto to be played back.

An Unavailable Audio Stream element in the clip element describing a Decoding Audio Stream in P-EVOBS is configured to be unavailable during a playback period of the clip. The XML Syntax Representation of the Unavailable Audio Stream element is as follows, for example:

```
<Unavailable Audio Stream
    number = integer
    />
```

The Unavailable Audio Stream element can be used only in a clip element for P-EVOB that exists in Primary Video Track elements. Otherwise, the Unavailable Audio Stream does not exist. In addition, a player disables a Decoding Audio Stream indicated by a number attribute.

An Unavailable Sub picture Stream element in clip elements describing a Decoding Sub-picture Stream in P-EVOBS is configured so as to be unavailable during a playback period of the clip. The XML Syntax Representation of the Unavailable Sub picture Stream element is as follows, for example:

```
<Unavailable Sub picture Stream
    number = integer
    />
```

The Unavailable Sub picture Stream element can be used only in clip elements for P-EVOB that exists in Primary Video Track elements. Otherwise, the Unavailable Sub picture Stream element does not exist. In addition, a player disables a decoding sub picture stream indicated by a number attribute.

A Chapter List element in title elements describes playback sequence information for the title. Here, the playback sequence defines a chapter start position in accordance with a time value on a Title Timeline. The XML Syntax Representation of the Chapter List element is as follows, for example:

<Chapter List>
Chapter+
</Chapter List>

The Chapter List element is composed of a list of chapter elements. The Chapter element describes a chapter start position on the Title Timeline. In accordance with the document sequence of the chapter elements in the chapter list, chapter numbers for an Advanced Navigation are continuously assigned from ‘1’. That is, the chapter start position in the Title Timeline is configured to be monotonically increased in accordance with the chapter numbers.

The Chapter element describes a chapter start position on the Title Timeline in a Playback Sequence. The XML Syntax Representation of the Chapter element is as follows, for example:

```
    <Chapter
        id = ID
        title Begin Time = time Expression
/>
```

The Chapter element has a title Begin Time attribute. A time Expression value of this title Begin Time attribute describes a chapter start position on the Title Timeline.

The title Begin Time attribute describes a chapter start position on the Title Timeline in the Playback Sequence, and the value thereof is described in the time Expression value.

<Datatypes>

A time Expression describes a time code in positive integer in units of 90 kHz, for example.

[Loading Information File]

A Loading Information File is initialization information of ADV_APP for titles, and a player is configured to launch ADV_APP in accordance with the information contained in the loading information file. This ADV_APP has a configuration made of presentation of Markup file and execution of Script.

The initialization information described in the Loading Information File is as follows:
Files to be first stored in a File Cache before executing initial markup file;
Initial markup files to be executed; and
Script file to be executed.

The Loading Information File needs to be encoded in a correct XML format, and rules are applied to an XML document file.

<Element and Attributes>

The syntax of the Loading Information File is defined using XML Syntax Representation.

An Application element is a root element of the Loading Information File, and includes the following elements and attributes:

XML Syntax Representation of Application element

```
    <Application
        id = ID
        >
            Resource* Script? Markup?
Boundary?
    </Application>
```

A Resource element describes a file to be stored in a File Cache before executing initial Markup. The XML Syntax Representation of a Playlist element is as follows, for example*

```
<Resource
        id = ID
        src = anyURI
        />
```

Here, an “src” attribute describes URI for files to be stored in the File Cache.

A Script element describes an initial Script file for ADV_APP. The XML Syntax Representation of the Script element is as follows, for example:

```
<Script
        id = ID
        src = anyURI
        />
```

At the time of application startup, a Script Engine loads a Script File referred to by URI in the “src” attribute, and then, executes the loaded file as a global code [ECMA 10.2.10]. The “src” attribute describes URI for initial Script file.

The Markup element describes an initial markup file for ADV_APP. The XML Syntax Representation of the Markup element is as follows, for example:

```
<Markup
        id = ID
        src = anyURI
        />
```

If an initial Scrip file exists at the time of application start, after executing the startup, an Advanced Navigation is configured to load a Markup file by referring to URI in the “src” attribute. Here, the “src” attribute describes URI for initial markup file.

A Boundary element can be configured to describe valid URL that can be referenced by an application.

<Markup File>

A markup File is information of a Presentation Object on a Graphics Plane. Only one markup file can exist simultaneously in an application. The markup file is composed of a content model, styling, and timing.

<Script File>

A Script File describes a Script global code. A Script Engine is configured to execute a Script file at the time of startup of ADV_APP, and then, wait for an event in an event handler defined by the executed Script global code.

Here, Script is configured to control a Playback Sequence and a Graphics on the Graphics Plane in accordance with events such as a User Input Event or a Player playback event.

<Playlist File: Described in XML (Markup Language)>

A reproducing apparatus (player) is configured to first playback a Playlist file (prior to Advanced Content playback) when a disc has the Advanced Content.

A Primary Video Set is configured to include Video Title Set Information (VTSI), Enhanced Video Object Set for Video Title Set (VTS_EVOBS), Backup of Video Title Set Information (VTSI_BUP), and Video Title Set Time Map Information (VTS_TMAPI).

Some of the following files can be maintained in an Archive without being compressed.

Manifest (XML)
Markup (XML)
Script (ECMAScript)
Image (JPEG/PNG/MNG)
Effect sound audio (WAV)
Font (OpenType)
Advanced Subtitle (XML)

In this standard, a file maintained in the Archive is called an advanced stream. This file can be stored in a disc (under an ADV_OBJ directory) or can be distributed from a server. In addition, this file is multiplexed in EVOB of a Primary Video Set. In this case, the file is divided into a pack called an advanced pack (ADV_PCK).

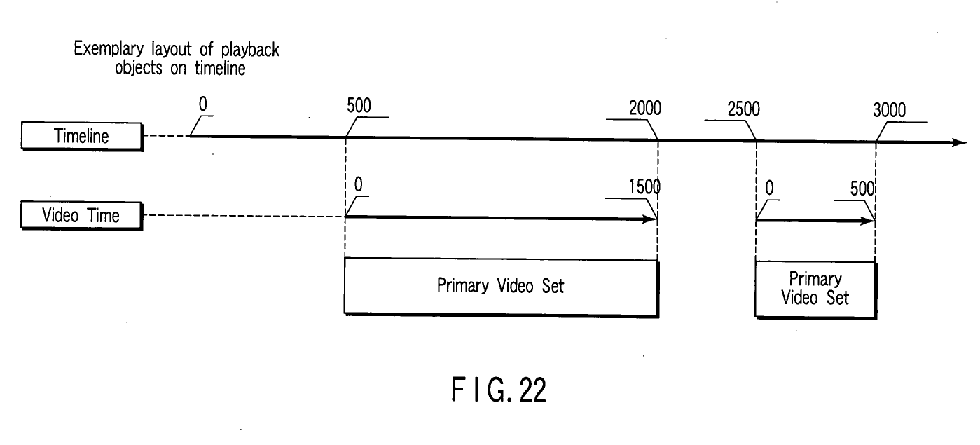

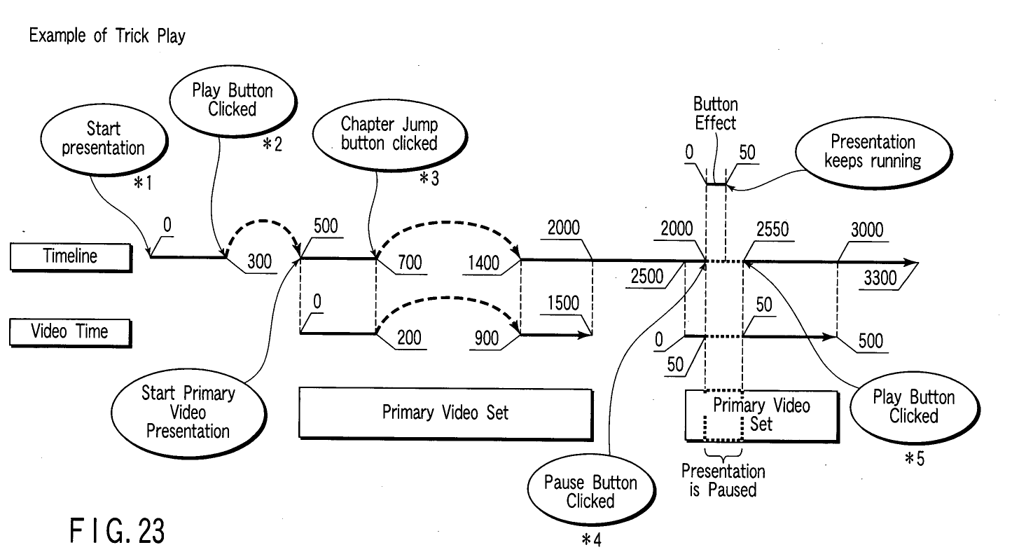

FIGS. 22 and 23 each give an explanation of Timeline used in a Playlist. FIG. 22 illustrates Allocation of Presentation Object on a Timeline. Here, a video frame unit, a unit of seconds (milliseconds), 90 kHz/27 MHz based clock unit, a unit specified by SMPTE and the like can be utilized for units of Timeline. In the example of FIG. 22, two Primary Video Sets respectively having time lengths of 1500 and 500 are prepared, and they are allocated to 500-1500 and 2500-3000 on Timeline that is one time axis. In this way, Objects having their respective time lengths are allocated onto Timeline that is one time axis, whereby their respective Objects can be reproduced without any discrepancy. Timeline can be configured to be zero reset for each playlist to be used.

FIG. 23 is a diagram to help explain an example in which a trick play (such as chapter jump) of a Presentation Object is carried out on Timeline. FIG. 23 shows an example of advancement of time on Timeline when a playback operation is actually made. That is, when playback is started, a time on Timeline starts advancement *1. When a Play button is pressed at time 300 *2, the time on Timeline jumps 500, and playback of a Primary Video Set is started. Then, when a Chapter Jump button is pressed at time 700 *3, it jumps to a start position of the corresponding Chapter (to time 400 on Timeline in this case), playback is started therefrom. Then, a Pause button is clicked (by the player user) at time 2550 *4, a button effect occurs, and then, playback is Paused. When the Play button is clicked at time 2550 *5, playback is restarted.

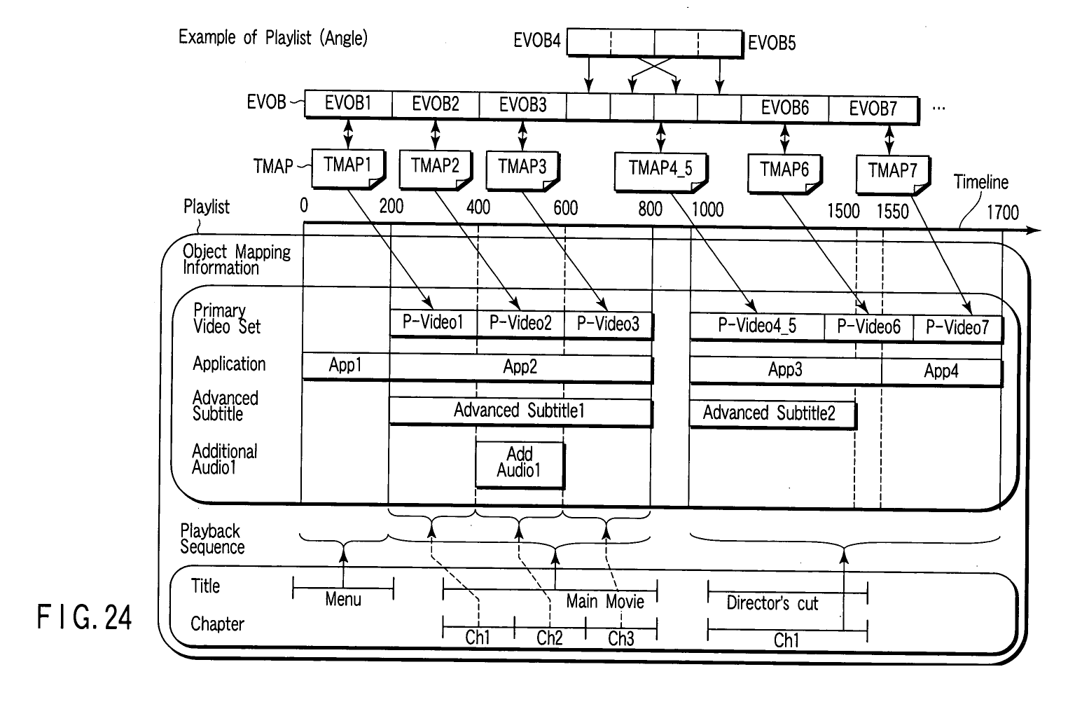

FIG. 24 shows an example of a playlist in the case where EVOB has an interleaved angle. EVOB has a TMAP file corresponding thereto. On the other hand, with respect to EVOB4 and EVOB5 that are interleaved angle blocks, information is written in the same TMAP file. In addition, the respective TMAP files are specified in Object Mapping Information, thereby mapping the Primary Video Set on Timeline. In addition, Application, Advanced Subtitle, Additional Audio and the like are mapped on Timeline in accordance with description of the Object Mapping Information in the playlist.

In the figure, as App1, Title that does not have Video or the like (such as Menu as its application) is defined between times 0 and 200 on Timeline. In addition, Application 2, Primary Videos 1-3, Advanced Subtitle 1, and Additional Audio 1 are set in a period of times 200 to 800. Primary Video 4_5 composed of EVOB4 and EVOB5 that configure an angle block, Primary Video 6, Primary Video 7, Applications 3 and 4, and Advanced Subtitle 2 are set in a period of times 1000 to 1700.

In addition, in a Playback sequence, it is defined that Appl configures Menu as one Title, App2 configures Main Movie, and App3 and App4 configure Director's cut. Further, Three Chapters and one Chapter are defined for Main Movie and Director's cut, respectively.

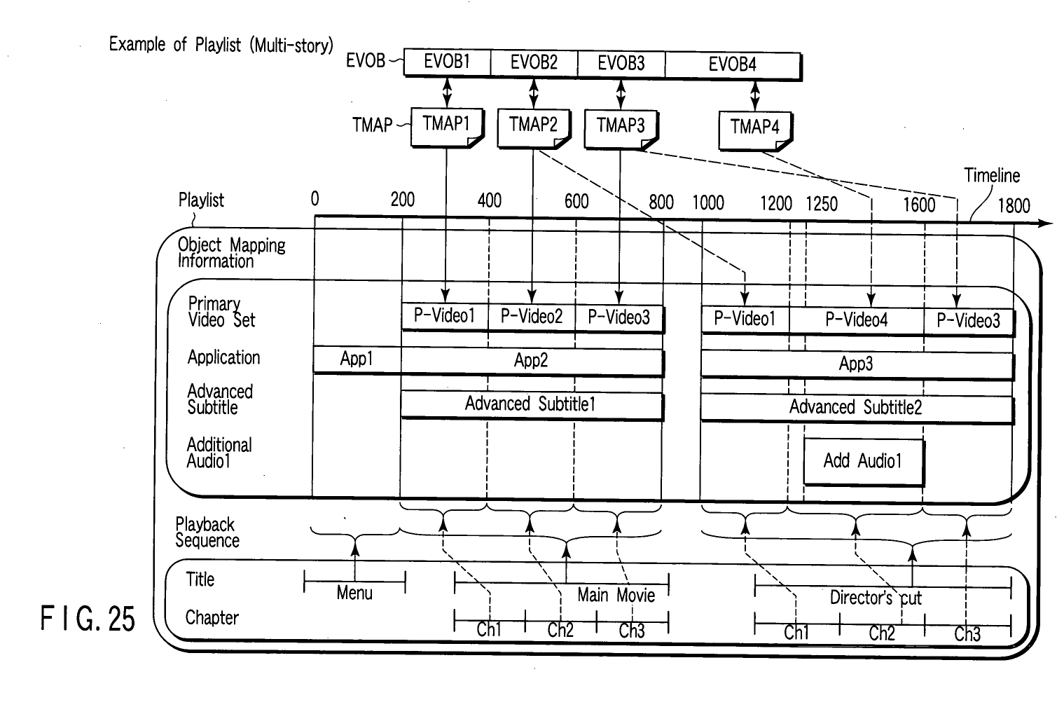

FIG. 25 is a diagram to help explain an exemplary configuration of a playlist in the case where an Object includes Multi-Story. FIG. 25 is an imaginary view of a playlist in the case of setting Multi-Story. TMAP is specified into the Object Mapping Information, whereby these two titles are mapped onto Timeline. In this example, EVOB1 and EVOB3 are used in both titles, and then, EVOB2 and EVOB4 are exchanged with each other, thereby enabling Multi-Story.

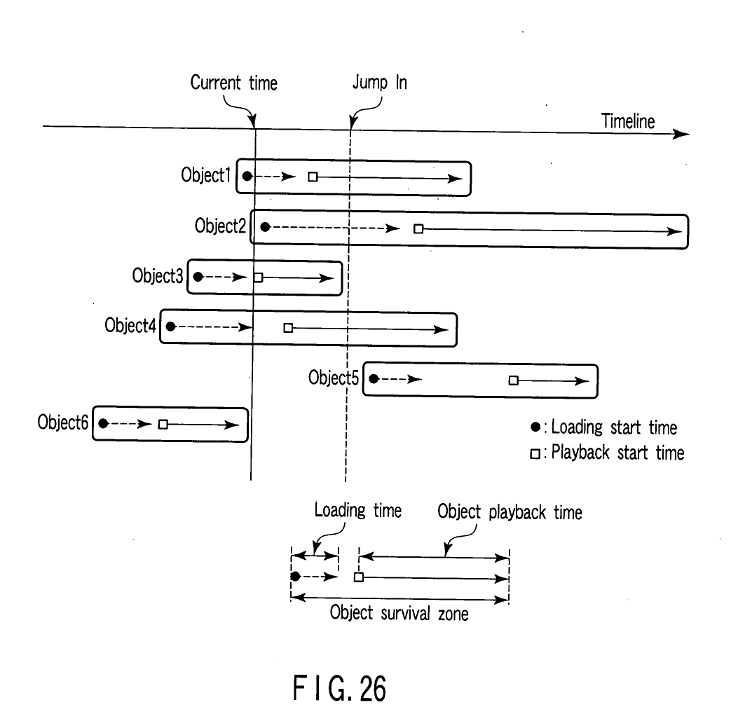

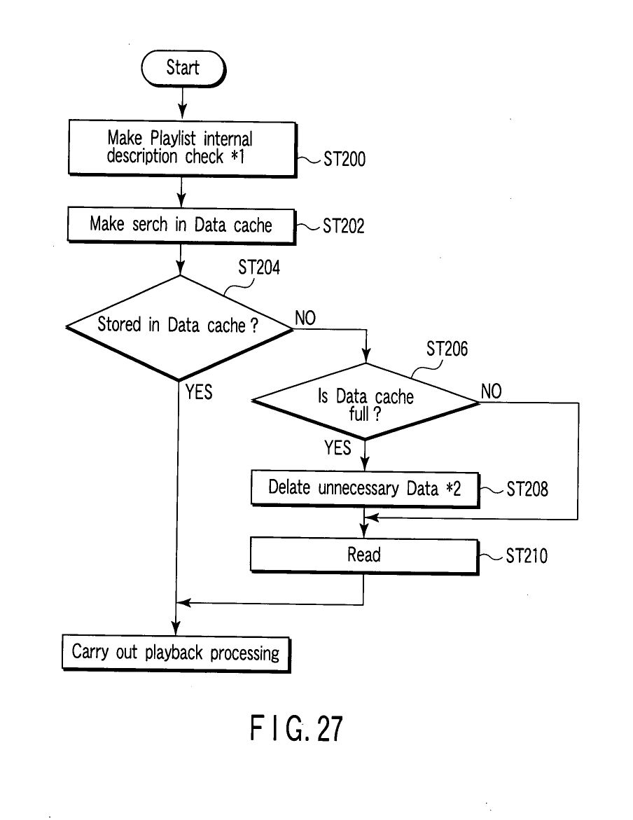

Further, a description will be given with respect to a playlist. FIGS. 26 and 27 are diagrams to help explain a playlist.

A playback time as well as a load time is described in the playlist. A read time is described in information of the playlist, thereby making it possible to measure (or detect) a use quantity of Data Cache. In this manner, the measurement (detection) result of the Data Cache use quantity is utilized, thereby enabling effective content production at the time of authoring. In addition, an Object that may not be erased is maintained in the Data Cache, thereby making it possible to improve the Player's performance. A further description will be given below.

FIG. 26 is a diagram exemplifying a playback time and a loading start time of each Object on Timeline. In the case where a current time expressed by the straight line in the figure jumps to a time expressed by the dotted line, Object 3 and Object 6 are at a time at which playback has already been terminated, and thus, there is no need for consideration thereof.

In addition, Object 5 does not arrive at a Loading start time yet, and thus, there is no need for consideration thereof. With respect to Object 1, although Loading has already started at a current time, it is not terminated. In addition, in a jump destination, this Object is in the middle of playback. Thus, contents similar to those of Object 1 owned by another file are loaded and played back. Object 2 has jumped to Loading in progress. Thus, with respect to this object as well, playback is started after Loading is completed by at least jump destination from the Loading start time.

Object 4 has jumped from a time at which Loading has been completed. Thus, the inside of Data cache is retrieved, and then, it is verified as to whether there exists is Object 4. If the existence is verified, playback is carried out. This can be accomplished by adding a Loadstart attribute to description of the playlist.

FIG. 27 is a flowchart corresponding to the above processing. In the case where a jump operation has been made, description in a playlist is checked (step ST200), and then, a search is made as to whether or not an Object is stored in a Data Cache (step ST202). In the case where the Object is stored in the Data Cache (Yes in step ST204), playback is carried out using it.

In the case where no Object is stored in the Data Cache (No in step ST204), it is checked whether or not there is any free space for storage in the Data Cache (step ST206). In the case where the Data Cache is full (Yes in step ST206), deletion of unnecessary objects is carried out (step ST208), required data is read from a file provided into the Data Cache (step St210), and then, playback is carried out.

In the case where there is a free space in the Data Cache (No in step ST206), Object deletion from the Data Cache is not carried out, reading of required data into the Data Cache is carried out (step ST210), and then, playback is carried out. In this manner, deletion of the stored contents is not carried out, thereby making it possible to retrieve and use the contents stored in the Data Cache in the case where the contents are required again by means of a jump operation or the like. Thus, the Player's capability can be improved by sufficiently providing the capacity of the Data Cache. In this manner, equipment differentiation can be promoted.

Further, the use quantity of the Data Cache by a predetermined times can be calculated (by adding the Loadstart attribute to the playlist), thus making it possible to set a further Object in location that serves as a free space for storage in the capacity of the Data Cache at the time of production of contents, and then, enabling effective production of contents.

Management of the playlist described above is carried out by means of a playlist Manager in a Navigation Manager.

Here, a File System is prepared for a File Cache Manager. This File System manages a File or an Archived file or Archived Data stored in a File Cache. Namely, file write/readout of the File cache is controlled upon request from the Navigation Manager, a Presentation Engine, an Advanced Element Engine, and a Data Access Manager. The File Cache is part of a Data Cache, and is utilized as a location for temporarily storing a file.

First, the File Cache is defined so as to have a storage region of at least 64 MB (Megabytes). The minimum capacity of the File Cache is defined, thereby making it possible to design a capacity of contents and management information of a recording medium. In addition, the size of one memory block in the File Cache is set to 512 bytes. This block size is determined as a consumption unit. Even if a one-byte file is written, 512 bytes are allocated, and then, are consumed. An access in units of 512 bytes enables easy, high-speed access. In addition, address management is facilitated.

The File Cache can handle multiple-file archived data (Archived Data) and non-archived files. For the name of the Archived Data, its file name is expressed using eight characters; extension is expressed using three characters; and a unique file name is assigned in a disc. In addition, the name of a file in the Archived Data is expressed using 32 bytes (including extension). In addition, the maximum file size is 64 MB. Further, the maximum number of files is defined to be 2000 in a disc and 2000 in Archive.

Resources are managed based on the following information. That is, mapping information on a Title Timeline described in Resource Information managed by a playlist Manager; and a File list and a Delete List described in a Resource Management Table managed by a File Cache Manager.

In an access from an Application Programming Interface (API), the data under the control of the playlist Manager is for readout only. A file in a temporary directory (Temp directory) prepared as an API directory can be read and written.

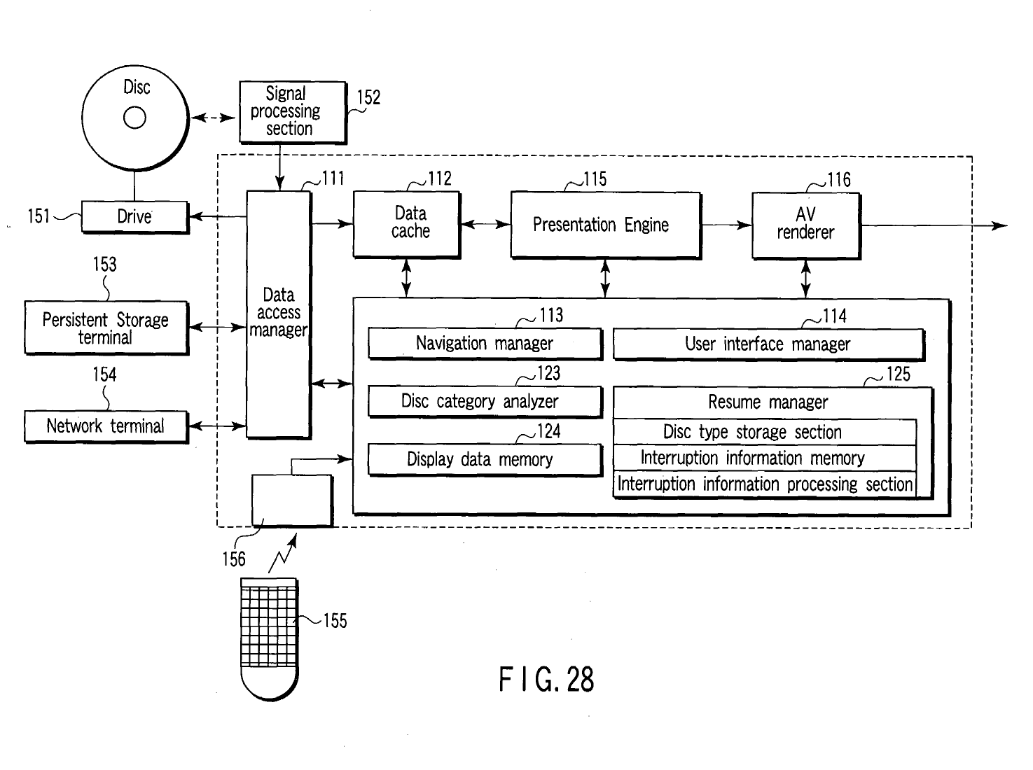

FIG. 28 simply shows a whole block of a player. The data recorded in a disc can be acquired in a Data Access Manager 111 via a signal processing section 152. A drive 151 provides disc rotation, tracking, and focus control. In addition, Persistent Storage Data can be acquired in the Data Access Manager 111 via a Persistent Storage Terminal 153. Further, Network Server Data can be acquired in the Data Access Manager 1111 via a Network Terminal 154. In addition, an operating signal from a Remote Controller 154 is acquired in a User Interface Manager 114 via a control signal receiving unit 156. Hereinafter, like constituent elements corresponding to those of FIG. 14 are designated by like reference numerals corresponding to those of FIG. 14. A duplicate description thereof is omitted here.

While certain embodiments of the inventions have been described, these embodiments have been presented by way of example only, and are not intended to limit the scope of the inventions. Indeed, the novel methods and systems described herein may be embodied in a variety of forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information reproducing apparatus, comprising:
a playback section which plays back contents of a plurality of different types;
a command section which commands interruption of contents being played back; and
a playback control section which, when playback of contents is restarted after interruption of contents, in the case where the contents are contents of a first type, restarts playback from an interrupted position, and, in the case where the contents are contents of a second type, reads and plays back a playlist indicating procedures for playing back the contents.

2. The information reproducing apparatus according to claim 1, further comprising:
a content type storage section which, when playback is started, determines whether disc contents are of the first type or second type, and then, stores content determination information; and
an interruption information storage section which, when playback interruption occurs while playing back the disc and when the contents are of the first type, stores information relating to a playback position in the management information.

3. The information reproducing apparatus according to claim 2, wherein the interruption information processing section determines information of the content type storage section when playback interruption occurs during a playback operation; stores information relating to the playback position in the interruption information storage section when the contents are of a first type; and aborts information relating to the playback position when the contents are of a second type.

4. The information reproducing apparatus according to claim 2, wherein the content type storage section checks determination that the contents are of a second type, in accordance with a disc identification data file under a directory of the disc.

5. The information reproducing apparatus according to claim 2, wherein the playback control section further sets a playback state from a start position of contents of the disc when a playback operation occurs after the playback interruption and when the contents are of a second type.

6. The information reproducing apparatus according to claim 2, wherein the playback control section further acquires the disc identification data file, and then, reads the playlist and sets a playback operation when a playback operation occurs after the playback interruption and when the contents are of a second type.

7. The information reproducing apparatus according to claim 2, wherein the playback control section reads a playlist indicating procedures for playing back advanced contents according to the disc and sets a playback state when a playback operation occurs after the playback interruption and the contents are of a second type.

8. The information reproducing apparatus according to claim 2, wherein the playback control section sets a playback state of the disc, based on information relating to a playback position of the interruption information storage section, when a playback operation occurs after the playback interruption and the contents are of a second type.

9. The information reproducing apparatus according to claim 1, wherein the playback section and the playback control section further comprises:
a user interface manager which accepts a user operation;
a data access manager which acquires data from a network server and a persistent storage in addition to the disc;
a data cache;
a presentation engine which decodes an output from the data cache; and
a navigation engine which controls the data cache and the presentation engine,
wherein the data access manager makes a search, from the disc or the persistent stage and the disc, for a playlist indicating procedures for playing back advanced contents according to the disc, in accordance with contents of a search flag included in the disc identification data file.

10. The information reproducing apparatus according to claim 1, wherein the playback section and the playback control section further comprises:
a user interface manager which accepts a user operation;
a data access manager which acquires data from a network server and a persistent storage in addition to the disc;
a data cache;
a presentation engine which decodes an output from the data cache; and
a navigation engine which controls the data cache and the presentation engine,
wherein, in accordance with operational information inputted from the user interface, the data access manager acquires contents from the network server and the persistent storage; the navigation engine and the data cache expand the acquired contents; and the presentation engine obtains a playback output of an object included in contents.

11. A information reproducing method comprising the steps of:
a user interface manager accepting a user operation;
a data access manager acquiring data from a network server and a persistent storage in addition to a disc;
a data cache caching data;
a presentation engine decoding an output from the data cache; and
a navigation engine controlling the data cache and the presentation engine,
wherein, in accordance with operational information inputted from the user interface, the data access manage acquires contents from the network server and the persistent storage; the navigation engine and the data cache expand the acquired contents; and the presentation engine obtains a playback output of an object included in contents, and
when a playback operation occurs after the playback interruption via the user interface section, the data access manager includes means for reading at least a playlist indicating procedures for playing back contents when the contents are of a predetermined type, and then, setting a playback state.

12. The information reproducing method according to claim 11, further comprising a resume manager, the resume manager including the steps of:
determining types of contents being played back and storing content determination information; and
when playback interruption occurs while playing back the contents and the contents are of a first type, storing information relating to the playback position in an interruption information storage section, and, when the contents are of the predetermined type (second type), aborting information relating to the playback position.

13. The information reproducing method according to claim 12, wherein determination that the contents are of a second type is made by verifying that a disc identification data file exists under a disc directory.

14. The information reproducing method according to claim 12, wherein, when a playback operation occurs after the playback interruption and the contents are of a second type, a video object of the disc is set to a playback state from an object start position.

15. The information reproducing method according to claim 12, wherein, when a playback operation occurs after the playback interruption and the contents are of a second type, the disc identification data file is acquired, and then, a playback operation is set.

16. The information reproducing method according to claim 12, wherein, when a playback operation occurs after the playback interruption and the contents are of a second type, a playlist indicating procedures for playing back advanced contents relevant to the disc is read, and then, a playback state is set.

17. The information reproducing method according to claim 12, wherein, when a playback operation occurs after the playback interruption and the contents are of a first type, a playback state of the disc is set based on information relating to a playback position of the interruption information storage section.
